(19) United States
(12) Patent Application Publication
(10) Pub. No.: US 2010/0021209 A1
(43) Pub. Date: Jan. 28, 2010

(54) TONER, DEVELOPER, AND IMAGE FORMING APPARATUS

(76) Inventors: Yohichiro WATANABE, Fuji-shi (JP); Kazumi Suzuki, Shizuoka-ken (JP); Takahiro Honda, Fujinomiya-shi (JP); Shinji Ohtani, Shizuoka-ken (JP); Yoshihiro Norikane, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/503,444

(22) Filed: Jul. 15, 2009

(30) Foreign Application Priority Data
Jul. 23, 2008 (JP) 2008-190078
Jan. 16, 2009 (JP) 2009-007857

(51) Int. Cl. G03G 15/08; G03G 9/097; G03G 9/087

(52) U.S. Cl. 399/252; 430/108.4; 430/137.14

(57) ABSTRACT

A toner produced by dissolving or dispersing toner components comprising a binder resin, a colorant, and a charge controlling agent in an organic solvent to prepare a toner components liquid, forming liquid droplets of the toner components liquid in a gas phase, and solidifying the liquid droplets into toner particles of the toner. The charge controlling agent includes a polycondensation reaction product of a phenol with an aldehyde.

### BACKGROUND OF THE INVENTION

1. Field of the Invention

The present invention relates to a toner for use in electrophotography, electrostatic recording, and electrostatic printing. The present invention also relates to a developer and an image forming apparatus using the toner.

2. Discussion of the Background

In a typical image forming in electrophotography, electrostatic recording, or electrostatic printing, a toner is adhered to an electrostatic latent image formed on an electrostatic latent image bearing member in a process called developing process. The toner is then transferred from the electrostatic latent image bearing member onto a transfer medium (e.g., transfer paper) in a process called transfer process. The toner is finally fixed on the transfer medium in a process called fixing process. Some toner particles may remain on the electrostatic latent image bearing member without being transferred onto the transfer medium. The remaining toner particles are preferably removed from the electrostatic latent image bearing member so as not to disturb formation of a next electrostatic latent image. To remove remaining toner particles, blade members are widely used because of their simple configuration and high ability to remove toner particles. However, it is known that blade members are poor at removing spherical and small-size toner particles.

Developers for developing electrostatic latent image formed on electrostatic latent image bearing member are broadly classified into two-component developer that includes a carrier and a toner, and one-component developer that includes no carrier and a toner. The toner may be either a magnetic toner or a non-magnetic toner.

In the developing and transfer processes, a charged toner moves by electrostatic force. Generally, each toner has an appropriate charge quantity that depends on the particle diameter and the developing and transfer processes. It may be preferable that toner can be quickly and reliably charged to an appropriate charge quantity regardless of temperature and humidity. Additionally, it may be also preferable that toner particles each have an appropriate charge quantity and a narrow charge quantity distribution. Further, it may be also preferable that charging sites are uniformly distributed over a toner particle.

In accordance with recent wide spread of full-color image forming, charge controlling agents are required to have no color or whitish color so as not to affect the resultant color tone. Various whitish charge controlling agent have been developed, but none of them satisfies safety standards.

For example, the following compounds have been disclosed as negative charge controlling agents. Examined Japanese Patent Application Publication No. (hereinafter JP-B) 02-22945 discloses 2:1-type metal complex salt compounds, but the compounds have problems in color tone and safety. JP-B 07-62766 discloses metal salts of salicylic acids. Some of these compounds have no problem in color tone but have problems in safety. In attempting to solve the problems in color tone and safety, Japanese Patent No. (hereinafter JP) 2568675 discloses calixarene compounds which include no metal and JP 3555562 discloses copolymers produced from sulfonic acid-based monomers. However, toners including these compounds may not be charged quickly and may have poor environmental stability.

Toners for use in electrophotography, electrostatic recording, and electrostatic printing are generally produced by so-called pulverization methods. In a typical pulverization method, a binder resin (such as a styrene resin and a polyester resin) and a colorant are melt-kneaded in a process called melt-kneading process, and the melt-kneaded mixture is pulverized into fine particles in a process called pulverization process. Disadvantageously, pulverization methods may consume a large amount of energy. In addition, resultant toner particles may have a large size distribution which needs a so-called classification process for collecting desired-size toner particles, resulting in deterioration of productivity.

JP 2851895 and JP 3772910 each disclose toners (hereinafter “pulverization toners”) which are produced by pulverization methods. In a typical pulverization method, a binder resin and internal additives such as a colorant, a charge controlling agent, and a release agent are melt-kneaded. The internal additives are dispersed in the binder resin. In the pulverization process, the melt-kneaded mixture is likely to pulverize from interfaces between the internal additives and the binder resin. Therefore, either inter-particle or intra-particle uniformity of the resultant toner particles may be poor. Additionally, because the pulverization toner has a wide size distribution, the resultant image quality may vary with time. The reason is as follows. With regard to two-component developers, toner particles are selectively and successively consumed in order of size, from large to small, in the dev eloping process, resulting in deterioration of image density with time. By comparison, with regard to one-component developers, toner particles are selectively and successively consumed in order of size, from small to large, in the developing process, resulting in deterioration of dot reproducibility and gradation with time.

To solve the problems of the pulverization methods and to respond to recent demand for reduction of environmental impact, so-called polymerization methods such as suspension polymerization methods, emulsion aggregation methods, and polymer dissolution suspension polymerization methods have been developed. These methods generally produce toners having a narrow size distribution and a uniform surface with less energy and without environment pollution.

Although having a narrow size distribution and a uniform surface, polymerization toners may have poor environmental stability in chargeability. This is because polymerization toners are generally produced in an aqueous medium including a dispersing agent. The dispersing agent is likely to remain on the surface of the resultant toner and degrade environmental stability in chargeability. To remove the remaining dispersing agent, a large amount of washing water is required, increasing environmental impact.

Also, spray-dry methods in which a toner components liquid is formed into liquid droplets and the liquid droplets are dried into solid particles have been proposed. However, the resultant toner may have a wide size distribution.

In attempting to more narrow the size distribution, JP 3786034 discloses a toner production method in which microdroplets of a toner components liquid are formed using piezoelectric pulse and then dried into toner particles. JP3952817 discloses a toner production method in which microdroplets of a toner components liquid are formed using thermal expansion within a nozzle and then dried into toner particles. JP 3786035 discloses a toner production method in which microdroplets of a toner components liquid are formed using an acoustic lens and then dried into toner particles. However, these methods have poor productivity because the number of droplets discharged from a nozzle per unit time is small. In addition, it may be difficult to prevent coalescence of droplets, which results in a broad particle diameter distribution of the resultant particles.

There is another problem that toner particles produced by these methods may be spherical due to surface tension of the toner components liquid. Such spherical toner particles are difficult to remove using blade members.

### SUMMARY OF THE INVENTION

Accordingly, an object of the present invention is to provide a toner and a developer which can be quickly charged regardless of environmental conditions and can be easily removed with blade members.

Another object of the present invention is to provide an image forming apparatus which can produce high quality images for an extended period of time.

These and other objects of the present invention, either individually or in combinations thereof, as hereinafter will become more readily apparent can be attained by a toner produced by a method comprising:

dissolving or dispersing toner components comprising a binder resin, a colorant, and a charge controlling agent in an organic solvent to prepare a toner components liquid;

forming liquid droplets of the toner components liquid in a gas phase; and

solidifying the liquid droplets into toner particles of the toner,

wherein the charge controlling agent comprises a polycondensation reaction product of a phenol with an aldehyde;

and a developer and an image forming apparatus using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an exemplary embodiment of a toner production apparatus including a horn vibrator;

FIG. 2 is a schematic cross-sectional view illustrating an embodiment of the liquid droplet injection unit illustrated in FIG. 1;

FIG. 3 is a schematic bottom view illustrating an embodiment of the liquid droplet injection unit illustrated in FIG. 1;

FIGS. 4 to 6 are schematic views illustrating exemplary embodiments of the horn vibrator;

FIGS. 7 to 9 are schematic cross-sectional views illustrating another exemplary embodiment of a liquid droplet injection unit;

FIG. 10 is a schematic view illustrating an embodiment of multiple liquid droplet injection units;

FIG. 11 is a schematic view illustrating another exemplary embodiment of a toner production apparatus including a ring vibrator;

FIG. 12 is a schematic cross-sectional view illustrating an embodiment of the liquid droplet injection unit illustrated in FIG. 11;

FIG. 13 is a schematic bottom view illustrating an embodiment of the liquid droplet forming unit illustrated in FIG. 11;

FIG. 14 is a schematic cross-sectional view illustrating an embodiment of the liquid droplet forming unit illustrated in FIG. 11;

FIG. 15 is a schematic cross-sectional view illustrating another embodiment of the liquid droplet forming unit illustrated in FIG. 11;

FIG. 16 is a schematic view illustrating another embodiment of multiple liquid droplet injection units;

FIGS. 17A and 17B are schematic bottom and cross-sectional views, respectively, illustrating an exemplary embodiment of the thin film illustrated in FIG. 11;

FIG. 18 is a cross-sectional view of the thin film illustrating the fundamental vibration mode;

FIGS. 19 and 20 are cross-sectional views of the thin film illustrating higher vibration modes;

FIG. 21 is a schematic view illustrating another embodiment of the thin film;

FIG. 22 is a schematic view illustrating another exemplary embodiment of a toner production apparatus employing a liquid resonance method;

FIG. 23 is an exploded view of an embodiment of the liquid droplet injection unit illustrated in FIG. 22;

FIG. 24 is a schematic cross-sectional view illustrating an embodiment of the liquid droplet injection unit illustrated in FIG. 22;

FIG. 25 is a schematic view of an example of formation of liquid droplets in the liquid droplet injection unit illustrated in FIG. 22;

FIGS. 26A to 26D are schematic views illustrating an exemplary method of forming nozzles having a two-step cross section;

FIG. 27 is a schematic view illustrating an exemplary embodiment of an image forming apparatus;

FIG. 28 is a schematic view illustrating another exemplary embodiment of an image forming apparatus;

FIG. 29 is a schematic view illustrating an embodiment of the image forming unit illustrated in FIG. 28;

FIG. 30 is a schematic view illustrating an exemplary embodiment of a process cartridge; and

FIGS. 31 to 34 are SEM images of exemplary mother toners.

### DETAILED DESCRIPTION OF THE INVENTION

An exemplary toner of the present invention includes a binder resin, a colorant, and a charge controlling agent including a polycondensation reaction product of a phenol with an aldehyde, and optionally includes a release agent and a magnetic material. Additionally, the toner may optionally include functional agents such as a fluidity improving agent and a cleanability improving agent, if desired.

### (Charge Controlling Agent)

Suitable charge controlling agents include negative charge controlling agents including a polycondensation reaction product of a phenol with an aldehyde.

Specific preferred examples of the phenol include a phenol compound such as a p-alkylphenol, a p-aralkylphenol, a p-phenylphenol, a p-hydroxybenzoate, and a mixture thereof. Each of these phenol compounds has one phenolic hydroxyl group, and hydrogen is bound to the ortho position relative to the phenolic hydroxyl group. Specific preferred examples of the aldehyde include paraformaldehyde, formaldehyde, paraldehyde, and furfural.

Specific examples of usable commercially available charge controlling agents include condensation-polymer-based charge controlling agents FCA-N series (from Fujikura Kasei Co., Ltd.), for example.

An exemplary method of producing an exemplary charge controlling agent is as follows, for example. A phenol and an aldehyde are added to xylene and subjected to a polycondensation reaction for 3 to 20 hours at a temperature between 80° C. and the boiling point of the solvent (i.e., xylene), preferably between 100° C. and the boiling point of the solvent, in the presence of a strong base such as a hydroxide of an alkaline metal or an alkaline-earth metal, while removing produced water. The reaction product is recrystallized using a poor solvent such as an alcohol. Alternatively, after removing the solvent by evaporation under reduced pressures, the reaction product may be washed with an alcohol such as methanol, ethanol, and isopropanol. Specific examples of usable strong bases include, but are not limited to, sodium hydroxide, rubidium hydroxide, and potassium hydroxide.

The toner preferably includes a polycondensation reaction product of a phenol with an aldehyde in an amount of from 0.1 to 5 parts by weight based on 100 parts by weight of toner components, so as to have good chargeability and a non-spherical shape. When the amount is too large, the toner may have poor fixability.

The polycondensation reaction product of a phenol with an aldehyde may be used in combination with other charge controlling agents such as Nigrosine dyes, triphenylmethane dyes, metal complex dyes including chromium, chelate compounds of molybdic acid, Rhodamine dyes, alkoxyamines, quaternary ammonium salts, alkylamides, phosphor and compounds including phosphor, tungsten and compounds including tungsten, fluorine-containing activators, metal salts of salicylic acid, and metal salts of salicylic acid derivatives.

Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, and a quaternary ammonium group.

### (Binder Resin)

Suitable binder resins preferably include no cross-linking structure so as to be soluble in solvents.

Specific examples of suitable binder resins include, but are not limited to, homopolymers and copolymers of vinyl monomers such as styrene monomers, acrylic monomers, and methacrylic monomers, polyester resins, polyol resins, phenol resins, polyurethane resins, polyamide resins, epoxy resins, xylene resins, terpene resins, coumarone-indene resins, polycarbonate resins, and petroleum resins.

Among these resins, polyester resins and copolymers of styrene monomers and (meth)acrylic monomers are preferable.

Specific examples of usable alcohol monomers for preparing polyester resins include, but are not limited to, diols such as ethylene glycol, propylene glycol, 1,3-bitanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and diols prepared by polymerizing bisphenol A with a cyclic ether such as ethylene oxide and propylene oxide.

Specific examples of usable acid monomers for preparing polyester resins include, but are not limited to, benzene dicarboxylic acids (e.g., phthalic acid, isophthalic acid, terephthalic acid) and anhydrides thereof; alkyl dicarboxylic acids (e.g., succinic acid, adipic acid, sebacic acid, azelaic acid) and anhydrides thereof; unsaturated dibasic acids (e.g., maleic acid, citraconic acid, itaconic acid, alkenylsuccinic acid, fumaric acid, mesaconic acid); and unsaturated dibasic acid anhydrides (e.g., maleic acid anhydride, citraconic acid anhydride, itaconic acid anhydride, alkenylsuccinic acid anhydride).

Polycarboxylic acids having 3 or more valences can also be used, but the amount thereof may be as small as possible so that any cross-linking structure is not formed. Specific examples of usable polycarboxylic acids having 3 or more valences include, but are not limited to, trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxyl)methane, 1,2,7,8-octanetetracarboxylic acid, and anhydrides and partial lower alkyl esters thereof.

Specific examples of usable styrene monomers include, but are not limited to, styrenes such as styrene, o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene, and derivatives thereof.

Specific examples of usable acrylic monomers include, but are not limited to, acrylic acids and esters thereof (i.e., acrylates) such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate, and phenyl acrylate.

Specific examples of usable methacrylic monomers include, but are not limited to, methacrylic acids and esters thereof (i.e., methacrylates) such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, and diethylaminoethyl methacrylate.

Specific examples of usable polymerization initiators for polymerization of vinyl polymers and copolymers include, but are not limited to, 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-(carbamoylazo)-isobutyronitrile, 2,2′-azobis(2,4,4-trimethylpentane), 2-phenylazo-2′,4′-dimethyl-4′-methoxyvaleronitrile, 2,2′-azobis(2-methylpropane), ketone peroxides (e.g., methyl ethyl ketone peroxide, acetylacetone peroxide, cyclohexanone peroxide), 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, di-cumyl peroxide, α-(tert-butylperoxy)isopropylbenzene, isobutyl peroxide, octanoyl peroxide, decanoyl peroxide, lauroyl peroxide, 3,5,5-trimethylhexanoyl peroxide, benzoyl peroxide, m-tolyl peroxide, di-isopropylperoxy dicarbonate, di-2-ethylhexylperoxy dicarbonate, di-n-propylperoxy dicarbonate, di-2-ethoxyethylperoxy carbonate, di-ethoxyisopropylperoxy dicarbonate, di(3-methyl-3-methoxybutyl)peroxy carbonate, acetylcyclohexylsulfonyl peroxide, tert-butylperoxy acetate, tert-butylperoxy isobutylate, tert-butylperoxy-2-ethylhexanoate, tert-butylperoxy laurate, tert-butyloxy benzoate, tert-butylperoxy isopropyl carbonate, di-tert-butylperoxy isophthalate, tert-butylperoxy allyl carbonate, isoamylperoxy-2-ethylhexanoate, di-tert-butylperoxy hexahydroterephthalate, and tert-butylperoxy azelate.

The binder resin preferably has a glass transition temperature (Tg) of from 35 to 80° C., and more preferably from 40 to 75° C., from the viewpoint of improving storage stability of the toner. When the Tg is too small, the toner is likely to deteriorate under high temperature atmosphere. When the Tg is too large, fixability of the toner may deteriorate.

### (Colorant)

Specific examples of usable colorants include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These materials can be used alone or in combination. The toner preferably includes a colorant in an amount of from 1 to 15% by weight, and more preferably from 3 to 10% by weight.

These colorants can be combined with a resin to be used as a master batch. Specific examples of usable resins for the master batch include, but are not limited to, polyester-based resins, styrene polymers and substituted styrene polymers (e.g., polystyrenes, poly-p-chlorostyrenes, polyvinyltoluenes), styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers), polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acids, rosins, modified rosins, terpene resins, aliphatic or alicyclic hydrocarbon resins, aromatic petroleum resins, chlorinated paraffins, and paraffin waxes. These resins can be used alone or in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner preferably includes the master batch in an amount of from 2 to 30 parts by weight based on 100 parts by weight of the binder resin.

The resin used for the master batch preferably has an acid value of 30 mgKOH/g or less and an amine value of from 1 to 100 mgKOH/g, and more preferably an acid value of 20 mgKOH/g or less and an amine value of from 10 to 50 mgKOH/g. When the acid value is too large, chargeability of the toner may deteriorate under high humidity conditions and dispersibility of the colorant may deteriorate. When the amine value is too small or large, dispersibility of the colorant may deteriorate. The acid value and the amine vale can be measured according to JIS K-0070 and JIS K-7237, respectively.

A colorant dispersing agent can be used in combination with the colorant. The colorant dispersing agent preferably has high compatibility with the binder resin in order to well disperse the colorant. Specific examples of usable commercially available colorant dispersing agents include, but are not limited to, AJISPER® PB-821 and PB-822 (from Ajinomoto-Fine-Techno Co., Inc.), DISPERBYK®-2001 (from BYK-Chemie Gmbh), and EFKA® 4010 (from EFKA Additives BV).

The colorant dispersing agent preferably has a weight average molecular weight, which is a local maximum value of the main peak observed in the molecular weight distribution measured by GPC (gel permeation chromatography) and converted from the molecular weight of styrene, of from 500 to 100,000, more preferably from 3,000 from 100,000, from the viewpoint of enhancing dispersibility of the colorant. In particular, the average molecular weight is preferably from 5,000 to 50,000, and more preferably from 5,000 to 30,000. When the average molecular weight is too small, the dispersing agent has a high polarity, and therefore dispersibility of the colorant may deteriorate. When the average molecular weight is too large, the dispersing agent has a high affinity for the solvent, and therefore dispersibility of the colorant may deteriorate.

The toner preferably includes the colorant dispersing agent in an amount of from 1 to 50 parts by weight, and more preferably from 5 to 30 parts by weight, based on 100 parts by weight of the colorant. When the amount is too small, the colorant may not be sufficiently dispersed. When the amount is too large, chargeability of the resultant toner may deteriorate.

### (Release Agent)

The toner may include a wax as a release agent to prevent the occurrence of offset when fixed.

Specific examples of usable waxes include, but are not limited to, aliphatic hydrocarbon waxes (e.g., low-molecular-weight polyethylene, low-molecular-weight polypropylene, polyolefin wax, microcrystalline wax, paraffin wax, SASOL wax), oxides of aliphatic hydrocarbon waxes (e.g., polyethylene oxide wax) and copolymers thereof, plant waxes (e.g., candelilla wax, carnauba wax, haze wax, jojoba wax), animal waxes (e.g., bees wax, lanoline, spermaceti wax), mineral waxes (e.g., ozokerite, ceresin, petrolatum), waxes including fatty acid esters (e.g., montanic acid ester wax, castor wax) as main components, and partially or completely deacidified fatty acid esters (e.g., deacidified carnauba wax).

In addition, the following compounds can also be used: saturated straight-chain fatty acids (e.g., palmitic acid, stearic acid, montanic acid, and other straight-chain alkyl carboxylic acid), unsaturated fatty acids (e.g., brassidic acid, eleostearic acid, parinaric acid), saturated alcohols (e.g., stearyl alcohol, eicosyl alcohol, behenyl alcohol, carnaubyl alcohol, ceryl alcohol, melissyl alcohol, and other long-chain alkyl alcohol), polyols (e.g., sorbitol), fatty acid amides (e.g., linoleic acid amide, olefin acid amide, lauric acid amide), saturated fatty acid bisamides (e.g., methylenebis capric acid amide, ethylenebis lauric acid amide, hexamethylenebis stearic acid amide), unsaturated fatty acid amides (e.g., ethylenebis oleic acid amide, hexamethylenebis oleic acid amide, N,N′-dioleyl adipic acid amide, N,N′-dioleyl sebacic acid amide), aromatic biamides (e.g., m-xylenebis stearic acid amide, N,N-distearyl isophthalic acid amide), metal salts of fatty acids (e.g., calcium stearate, calcium laurate, zinc stearate, magnesium stearate), aliphatic hydrocarbon waxes to which a vinyl monomer such as styrene and an acrylic acid is grafted, partial ester compounds of a fatty acid (such as behenic acid monoglyceride) with a polyol, and methyl ester compounds having a hydroxyl group obtained by hydrogenating plant fats.

More specifically, the following compounds are preferable: a polyolefin obtained by radical polymerizing an olefin under high pressure; a polyolefin obtained by purifying low-molecular-weight by-products of a polymerization reaction of a high-molecular-weight polyolefin; a polyolefin polymerized under low pressure in the presence of a Ziegler catalyst or a metallocene catalyst; a polyolefin polymerized using radiation, electromagnetic wave, or light; a low-molecular-weight polyolefin obtained by thermally decomposing a high-molecular-weight polyolefin; paraffin wax; microcrystalline wax; Fischer-Tropsch wax; synthesized hydrocarbon waxes synthesized by Synthol method, Hydrocaol method, or Arge method; synthesized waxes including a compound having one carbon atom as a monomer unit; hydrocarbon waxes having a functional group such as hydroxyl group and carboxyl group; mixtures of a hydrocarbon wax and a hydrocarbon wax having a functional group; and these waxes to which a vinyl monomer such as styrene, a maleate, an acrylate, a methacrylate, and a maleic anhydride is grafted.

In addition, these waxes may be preferably subjected to a press sweating method, a solvent method, a recrystallization method, a vacuum distillation method, a supercritical gas extraction method, or a solution crystallization method, so as to more narrow the molecular weight distribution thereof. Further, low-molecular-weight solid fatty acids, low-molecular-weight solid alcohols, low-molecular-weight solid compounds, and other compounds from which impurities are removed are preferable.

The wax preferably has a melting point of from 60 to 140° C., and more preferably from 70 to 120° C., so that the resultant toner has a good balance of toner blocking resistance and offset resistance. When the melting point is too small, toner blocking resistance may deteriorate. When the melting point is too large, offset resistance may deteriorate.

The melting point of a wax is defined as a temperature at which the maximum endothermic peak is observed in an endothermic curve measured by DSC.

As a DSC measurement instrument, a high-precision inner-heat power-compensation differential scanning colorimeter is preferable. The measurement is performed according to ASTM D3418-82. The endothermic curve is obtained by heating a sample at a temperature increasing rate of 10° C./min, after once heated and cooled the sample.

The toner preferably includes a wax in an amount of from 1 to 30% by weight, more preferably from 2 to 20% by weight, based on the toner.

### (Magnetic Material)

The toner may optionally include a magnetic material. Specific examples of usable magnetic materials include, but are not limited to, (1) magnetic iron oxides such as magnetite, maghemite, and ferrite, and iron oxides including other metal oxides, (2) metals such as iron, cobalt, and nickel, and alloys of these metals with aluminum, cobalt, copper, lead, magnesium, tin, zinc, antimony, beryllium, bismuth, cadmium, calcium, manganese, selenium, titanium, tungsten, vanadium, etc., and (3) mixtures of the above materials.

More specifically, preferred examples of usable magnetic materials include, but are not limited to, Fe₃O₄, γ-Fe₂O₃, ZnFe₂O₄, Y₃Fe₅O₁₂, CdFe₂O₄, Gd₃Fe₅O₁₂, CuFe₂O₄, PbFe₁₂O, NiFe₂O₄, NdFe₂O, BaFe₁₂O₁₉, MgFe₂O₄, MnFe₂O₄, LaFeO₃, iron powder, cobalt powder, and nickel powder. These materials can be used alone or in combination. Among these materials, fine powders of Fe₃O₄ and γ-Fe₂O₃ are preferable.

In addition, magnetic iron oxides (such as magnetite, maghemite, and ferrite) which include heterogeneous elements, and mixtures thereof are also preferable. Specific examples of the heterogeneous elements include, but are not limited to, lithium, beryllium, boron, magnesium, aluminum, silicon, phosphor, germanium, zirconium, tin, sulfur, calcium, scandium, titanium, vanadium, chrome, manganese, cobalt, nickel, copper, zinc, and gallium. Among these elements, magnesium, aluminum, silicon, phosphor, and zirconium are preferable. Heterogeneous elements may be incorporated in crystal lattice of iron oxides. Alternatively, oxides of heterogeneous elements may be incorporated in iron oxides. Further, oxides or hydroxides of heterogeneous elements may be present on the surface of iron oxides. It is most preferably that oxides of heterogeneous elements are incorporated in iron oxides.

In order to incorporate a heterogeneous element in a magnetic material, a magnetic material may be produced in the presence of a salt of a heterogeneous element while controlling pH. In order to deposit a heterogeneous element on a surface of a magnetic material, a salt of a heterogeneous element is mixed with a magnetic material while controlling pH.

The toner preferably includes a magnetic material in an amount of from 10 to 200 parts by weight, more preferably from 20 to 150 parts by weight, based on 100 parts by weight of the binder resin. The magnetic material preferably has a number average particle diameter of from 0.1 to 1 μm, and more preferably from 0.1 to 0.5 μm. The number average particle diameter can be determined by magnifying and photographing a magnetic material with a transmission electron microscope and measuring the photograph using a digitizer.

The magnetic material preferably has a coercivity of from 20 to 150 oersted, a saturated magnetization of from 50 to 200 emu/g, and a remanent magnetization of from 2 to 20 emu/g.

The magnetic material can be also used as a colorant.

### (Organic Solvent)

Toner components such as a binder resin, a colorant, a charge controlling agent are dissolved or dispersed in an organic solvent to prepare a toner components liquid. The toner components liquid is formed into liquid droplets in a gas phase and the liquid droplets are dried into toner particles. Accordingly, suitable organic solvents may dissolve the binder resin and may form stable dispersions. Additionally, suitable solvents may be easily removable by drying.

Specific examples of usable organic solvents include, but are not limited to, ethers, ketones, esters, hydrocarbons, and alcohols. More specifically, tetrahydrofuran (THF), acetone, methyl ethyl ketone (MEK), ethyl acetate and toluene are preferable. These organic solvents can be used alone or in combination.

The toner components liquid is subjected to a dispersion treatment using a homomixer or a bead mill so that colorants and release agents are finely dispersed so as not to cause nozzle clogging.

The toner components liquid preferably includes solid components in an amount of from 5 to 40% by weight. When the amount is too small, productivity of toner may decrease. In addition, dispersoids such as colorants, release agents, and magnetic materials may precipitate or aggregate, and make the resultant toner particles uneven. When the amount is too large, small-size toner particles may not be produced.

### (Fluidity Improving Agent)

The toner may include a fluidity improving agent that enables the resultant toner to easily fluidize. Fluidity improving agents are added to the surfaces of toner particles.

Specific examples of usable fluidity improving agents include, but are not limited to, fine powders of fluorocarbon resins such as vinylidene fluoride and polytetrafluoroethylene; fine powders of silica prepared by a wet process or a dry process, titanium oxide, and alumina; and these silica, titanium oxide, and alumina surface-treated with a silane-coupling agent, a titanium-coupling agent, or a silicone oil. Among these, fine powders of silica, titanium oxide, and alumina are preferable, and silica surface-treated with a silane-coupling agent or a silicone oil is more preferable.

The fluidity improving agent preferably has an average primary particle diameter of from 0.001 to 2 μm, and more preferably from 0.002 to 0.2 μm.

A fine powder of silica is prepared by a vapor phase oxidization of a halogenated silicon compound, and typically called a dry process silica or a fumed silica.

Specific examples of usable commercially available fine powders of silica prepared by a vapor phase oxidization of a halogenated silicon compound include, but are not limited to, AEROSIL® 130, 300, 380, TT600, MOX170, MOX80, and COK84 (from Nippon Aerosil Co., Ltd.), CAB-O-SIL® M-5, MS-7, MS-75, HS-5, and EH-5 (from Cabot Corporation), WACKER HDK® N20, V15, N20E, T30, and T40 (from Wacker Chemie Gmbh), Dow Corning® Fine Silica (from Dow Coming Corporation), and FRANSIL (from Fransol Co.).

A hydrophobized fine powder of silica prepared by a vapor phase oxidization of a halogenated silicon compound is more preferable. The hydrophobized silica preferably has a hydrophobized degree of from 30 to 80%, measured by a methanol titration test. The hydrophobic property is imparted to a silica when an organic silicon compound is reacted with or physically adhered to the silica. A hydrophobizing method in which a fine powder of silica prepared by a vapor phase oxidization of a halogenated silicon compound is treated with an organic silicon compound is preferable.

Specific examples of the organic silicon compounds include, but are not limited to, hydroxypropyltrimethoxysilane, phenyltrimethoxysilane, n-hexadecyltrimethoxysilane, n-octadecyltrimethoxysilane, vinyltrimethoxysilane, vinyltriethoxysilane, vinyltriacetoxysilane, dimethylvinylchlorosilane, divinylchlorosilane, γ-methacryloxypropyltrimethoxysilane, hexamethyldisilazane, trimethylsilane, trimethylchlorosilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, trimethylethoxysilane, trimethylmethoxysilane, methyltriethoxysilane, isobutyltrimethoxysilane, dimethyldimethoxysilane, diphenyldiethoxysilane, hexamethyldisiloxane, 1,3-divinyltetramethyldisiloxane, 1,3-diphenyltetramethyldisiloxane, dimethylpolysiloxane having 2 to 12 siloxane units per molecule and 0 to 1 hydroxyl group bound to Si in the terminal siloxane units, and silicone oils such as dimethyl silicone oil. These can be used alone or in combination.

The fluidity improving agent preferably has a number average particle diameter of from 5 to 100 nm, and more preferably from 5 to 50 nm.

The fluidity improving agent preferably has a specific surface area of 30 m²/g or more, and more preferably from 60 to 400 m²/g, measured by nitrogen adsorption BET method.

The surface-treated fluidity improving agent preferably has a specific surface area of 20 m²/g or more, and more preferably from 40 to 300 m²/g, measured by nitrogen adsorption BET method.

The toner preferably includes the fluidity improving agent in an amount of from 0.03 to 8 parts by weight based on 100 parts by weight of the toner.

### (Cleanability Improving Agent)

A cleanability improving agent is added to the toner so as to effectively remove toner particles remaining on the surface of a photoreceptor or a primary transfer medium after a toner image is transferred onto a recording medium. Specific examples of usable cleanability improving agents include, but are not limited to, fatty acids and metal salts thereof such as zinc stearate and calcium stearate; and particulate polymers such as polymethyl methacrylate and polystyrene, which are manufactured by a method such as soap-free emulsion polymerization methods. Particulate resins having a relatively narrow particle diameter distribution and a volume average particle diameter of from 0.01 μm to 1 μm are preferably used as the cleanability improving agent.

The fluidity improving agent and the cleanability improving agent are fixed on the surface of toner particles. Therefore, these agents are generally called external additives. Suitable mixers for mixing the toner particles and the external additive include known mixers for mixing powders. Specific examples of the mixers include V-form mixers, locking mixers, Loedge Mixers, NAUTER MIXERS, HENSCHEL MIXERS and the like mixers. When fixing the external additive on the surface of the mother toner particles, HYBRIDIZER, MECHANOFUSION, Q-TYPE MIXER, etc. can be used.

### (Particle Diameter Distribution)

Generally, as the particle diameter of toner becomes smaller, reproducibility of dots and thin lines improves and high quality images with high granularity are provided. However, when the particle diameter is too small, apparent adhesion forces may increase and degrade developability and transferability. Accordingly, the toner preferably has a weight average particle diameter of from 1 to 15 μm, more preferably from 2 to 10 μm, and much more preferably from 3 to 8 μm.

The ratio (D4/Dn) of the weight average particle diameter (D4) to the number average particle diameter (Dn) indicates particle diameter distribution. When D4/Dn is 1, it means that the particle diameter distribution is monodisperse. D4/Dn of typical pulverization toners may be from 1.2 to 1.4. Either in one-component developing methods or in two-component developing methods, toner particles are selectively and successively consumed in order of size, resulting in deterioration of image density with time. Therefore, the particle diameter distribution of toner is preferably as narrow as possible. To reliably produce high quality images, D4/Dn is preferably from 1.00 to 1.15, and more preferably from 1.00 to 1.10.

The toner may be used for a two-component developer by mixing with a carrier. The carrier may be a ferrite, a magnetite, or a resin-coated carrier, for example.

The resin-coated carrier includes a core and a coating resin. Specific examples of usable coating resins include, but are not limited to, styrene-acrylic resins such as styrene-acrylate copolymers and styrene-methacrylate copolymers; acrylic resins such as acrylate copolymers and methacrylate copolymers; fluorine-containing resins such as polytetrafluoroethylene, monochlorotrifluoroethylene polymers, and polyvinylidene fluoride; and other resins such as silicone resins, polyester resins, polyamide resins, polyvinyl butyral, amino acrylate resins, ionomer resins, and polyphenylene sulfide resins. These resins can be used alone or in combination.

The carrier may also be a binder-type carrier comprised of a resin in which powders of magnetic materials are dispersed.

An exemplary method of coating core with coating resin includes, for example, dissolving or suspending a coating resin in a solvent and applying the resultant solution or suspension to a core. Another exemplary method includes simply mixing a resin and a core in powder state.

The carrier preferably includes the coating resin in an amount of from 0.01 to 5% by weight, more preferably from 0.1 to 1% by weight, based on the carrier.

Among the above-described usable coating resins, styrene-methyl methacrylate copolymers, mixtures of a fluorine-containing resin with a styrene copolymer, and silicone resins are preferable, and silicone resins are most preferable.

Specific examples of usable mixtures of a fluorine-containing resin with a styrene copolymer include, but are not limited to, a mixture of a polyvinylidene fluoride with a styrene-methyl methacrylate copolymer; a mixture of a polytetrafluoroethylene with a styrene-methyl methacrylate copolymer; and a mixture of a vinylidene fluoride-tetrafluoroethylene copolymer (copolymerization weight ratio is 10:90 to 90:10), a styrene-2-ethylhexyl acrylate copolymer (copolymerization weight ratio is 10:90 to 90:10), and a styrene-2-ethylhexyl acrylate-methyl methacrylate copolymer (copolymerization weight ratio is (20 to 60):(5 to 30):(10 to 50)).

Specific examples of usable silicone resins include, but are not limited to, nitrogen-containing silicone resins and modified silicone reins which are prepared by a reaction between a nitrogen-containing silane coupling agent and a silicone resin.

Specific examples of usable magnetic materials for the core include, but are not limited to, oxides such as ferrite, iron excess ferrite, magnetite, and γ-iron oxide, and metals such as iron, cobalt, and nickel and alloys thereof.

These magnetic materials may include an element such as iron, cobalt, nickel, aluminum, copper, lead, magnesium, tin, zinc, antimony, beryllium, bismuth, calcium, manganese, selenium, titanium, tungsten, and vanadium. In particular, copper-zinc-iron ferrites that include copper, zinc, and iron as main components and manganese-magnesium-iron ferrites that include manganese, magnesium, and iron are preferable.

The resistivity of carrier is preferably set to between 10⁶ and 10¹⁰ Ω·cm by controlling asperity of the surface and the amount of coating resin.

The carrier preferably has a particle diameter of from 4 to 200 μm, more preferably from 10 to 150 μm, and much more preferably from 20 to 100 μm. In particular, resin-coated carriers preferably have a 50% cumulative particle diameter of from 20 to 70 μm.

Two-component developers preferably include the toner in an amount of from 1 to 10 parts by weight, more preferably from 2 to 50 parts by weight, based on 100 parts by weight of a carrier.

The toner may also be used for one-component developers.

### (Toner Production Method)

Conventional pulverization methods and exemplary spraying methods and vibration injection method of the present invention are compared below.

In a typical pulverization method, first, toner components are melt-kneaded using a double roll or a double axis extruder. After being cooled, the kneaded mixture is pulverized into coarse particles using a ROATPLEX or a pulverizer. The coarse particles are pulverized into fine particles using a jet mill or a TURBO MILL. The fine particles are classified by size using an ELBOW-JET or a wind power classifier, optionally followed by mixing with external additives (such as a fluidizer) using a HENCHEL MIXER.

In a typical spraying method, liquid droplets of a toner components liquid are formed in a gas phase using a single-fluid nozzle (pressurization nozzle) that sprays a liquid by pressurizing the liquid, a multi-fluid nozzle that sprays a liquid by mixing the liquid with a compressed gas, or a rotating-disk spraying device that forms liquid droplets using centrifugal force of the rotating disk. Commercially available spray-dry systems which perform spraying and drying simultaneously are usable. In a case in which drying is insufficient, secondary drying may be performed using a fluidized bed. Resultant particles may be optionally mixed with external additives (such as a fluidizer) using a HENCHEL MIXER.

In a typical vibration injection method, a toner components liquid is periodically discharged from multiple nozzles that are provided on a thin film. The thin film is vibrated by a mechanical vibration unit so that liquid droplets of the toner components liquid are formed. The multiple nozzles each have the same aperture diameter. The mechanical vibration unit vibrates in a vertical direction relative to the thin film. Exemplary embodiments of such mechanical vibration units include a horn vibrator and a ring vibrator, for example. An exemplary horn vibrator includes a vibrating surface that is provided parallel to the thin film. The vibrating surface vibrates in a vertical direction. An exemplary ring vibrator includes a circular vibration generating unit that is provided surrounding the nozzles on the thin film.

For the sake of simplicity, the same reference number will be given to identical constituent elements such as parts and materials having the same functions and redundant descriptions thereof omitted unless otherwise stated.

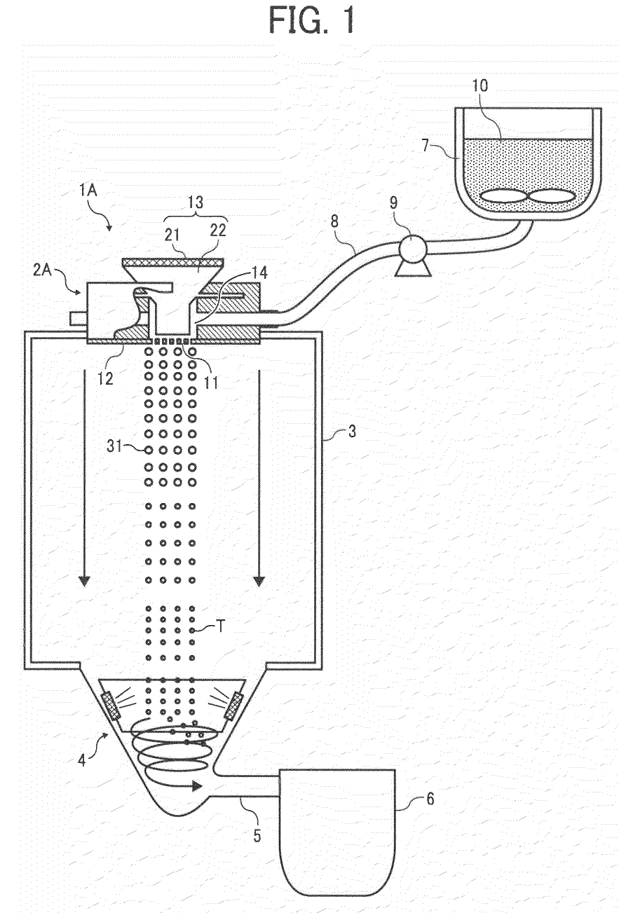

FIG. 1 is a schematic view illustrating an exemplary embodiment of a toner production apparatus 1A including a horn vibrator.

The toner production apparatus 1A includes a liquid droplet injection unit 2A, a toner particle formation part 3, a toner collection part 4, a toner retention part 6, a raw material container 7, a pipe 8, and a pump 9. The liquid droplet injection unit 2A includes a horn vibrator, and is configured to discharge a toner components liquid 10 to form liquid droplets 31 thereof. The toner particle formation part 3 is configured to form toner particles T by solidifying the liquid droplets 31 of the toner components liquid 10 discharged from the liquid droplet injection unit 2A. The toner collection part 4 is configured to collect the toner particles T formed in the toner particle formation part 3. The toner retention part 6 is configured to retain the toner particles T transported from the toner collection part 4 through a tube 5. The raw material container 7 is configured to contain the toner components liquid 10. The pipe 8 is configured to pass the toner components liquid 10 from the raw material container 7 to the liquid droplet injection unit 2A. The pump 9 is configured to supply the toner components liquid 10 by pressure when the apparatus starts operation, for example.

The toner components liquid 10 is self-supplied from the raw material container 7 when the liquid droplet injection unit 2A discharges liquid droplets 31. When the apparatus starts operation, the toner components liquid 10 is supplementarily supplied by the pump 9.

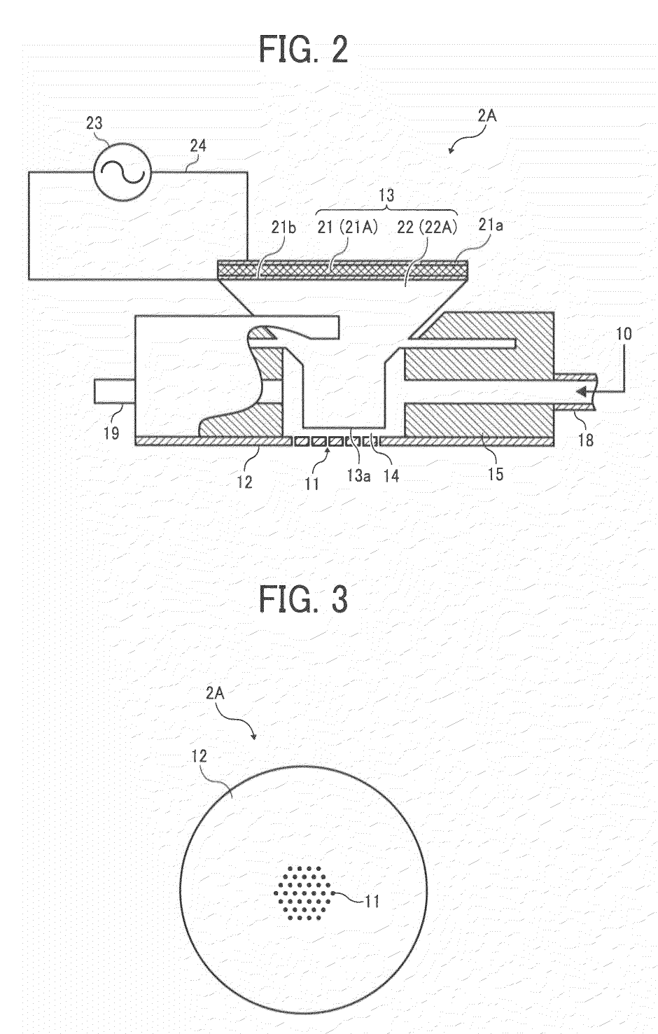

FIG. 2 is a schematic cross-sectional view illustrating an embodiment of the liquid droplet injection unit 2A. FIG. 3 is a schematic bottom view illustrating an embodiment of the liquid droplet injection unit 2A.

The liquid droplet injection unit 2A includes a thin film 12, a mechanical vibration unit 13 (hereinafter simply “vibration unit 13”), and a flow path member 15. The thin film 12 includes multiple nozzles 11. The vibration unit 13 is configured to vibrate the thin film 12. The flow path member 15 forms a liquid flow path and supplies the toner components liquid 10 to a retention part 14 that is formed between the thin film 12 and the vibration unit 13.

The thin film 12 that includes the multiple nozzles 11 is provided parallel to a vibrating surface 13a of the vibration unit 13. A part of the thin film 12 is fixed to the flow path member 15 with solder or a binder resin which does not dissolve in the toner components liquid 10. The thin film 12 is provided substantially vertical to the direction of vibration of the vibration unit 13. A communication member 24 transmits an electrical signal from a driving signal generating source 23 to the upper and lower surfaces of a vibration generating unit 21 of the vibration unit 13 so that the electrical signal is converted into mechanical vibration. Preferably, the communication member 24 may be a lead wire of which the surface is insulation-coated. The vibration unit 13 preferably includes a vibrator having a large amplitude, such as a horn vibrator and a bolted Langevin vibrator, in order to effectively and reliably produce toner.

The vibration unit 13 includes the vibration generating unit 21 a vibration amplifying unit 22. The vibration generating unit 21 generates a vibration, and the vibration amplifying unit 22 amplifies the vibration generated by the vibration generating unit 21. Upon application of a driving voltage (driving signal) having a specific frequency from the driving signal generating source 23 to electrodes 21a and 21b of the vibration generating unit 21, a vibration is generated by the vibration generating unit 21 and amplified by the vibration amplifying unit 22. As a result, the vibrating surface 13a periodically vibrates, and the thin film 12 also vibrates at a specific frequency due to periodical application of pressure from the vibrating surface 13a.

The vibration unit 13 is configured to reliably apply vertical vibration to the thin film 12 at a constant frequency. Exemplary embodiments of the vibration unit 13 include a piezoelectric substance 21A which excites bimorph flexural vibration. The piezoelectric substance 21A has a function of converting electrical energy into mechanical energy. Flexural vibration is excited upon application of voltage, thereby vibrating the thin film 12.

The piezoelectric substance 21A may be a piezoelectric ceramic such as lead zirconate titanate (PZT), for example. Because of vibrating with a small displacement, such a substance is often laminated when used as the piezoelectric substance 21A. Alternatively, the piezoelectric substance 21A may be a piezoelectric polymer such as polyvinylidene fluoride (PVDF) or a single crystal of quartz, LiNbO₃, LiTaO₃, or KNbO₃, for example.

The vibrating surface 13a is provided in parallel with the thin film 12 so that the thin film 12 is vibrated in vertical direction.

The vibration unit 13 illustrated in FIG. 2 is a horn vibrator. In the horn vibrator, the amplitude of the vibration generating unit 21 (such as the piezoelectric substance 21A) can be amplified by the vibration amplifying unit 22 (such as a horn 22A). Therefore, the vibration generating unit 21 itself need not vibrate at a large amplitude, reducing mechanical load to the vibration generating unit 21. Accordingly, a lifespan of the apparatus can be lengthened.

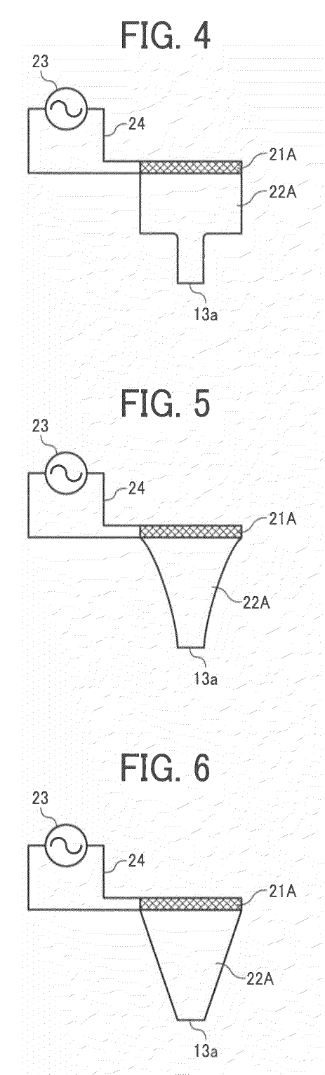

Exemplary embodiments of the horn vibrator include a step-type horn vibrator as illustrated in FIG. 4, an exponential-type horn vibrator as illustrated in FIG. 5, and a conical-type horn vibrator as illustrated in FIG. 6, for example. In these horn vibrators, the piezoelectric substance 21A is provided on a larger surface of the horn 22A so that the horn 22A is effectively excited to vibrate by vertical vibration of the piezoelectric substance 21A. The vibrating surface 13a is provided on a smaller surface of the horn 22A so that the vibrating surface 13a vibrates at the maximum amplitude. The communication member 24 (e.g., a lead wire) is provided on the upper and lower surfaces of the piezoelectric substance 21A so that an alternating voltage signal is transmitted from the driving signal generating source 23. The shape of the horn vibrator is designed so that the vibrating surface 13a becomes the maximum vibrating surface in the horn vibrator.

Alternatively, the vibration unit 13 may be a bolted Langevin vibrator having high strength, for example. Since a piezoelectric ceramic is mechanically connected, the bolted Langevin vibrator is unlikely to be damaged even when vibrating at a large amplitude.

Referring back to FIG. 2, at least one liquid supplying tube 18 is provided on the retention part 14. The liquid supplying tube 18 is configured to introduce the toner components liquid 10 to the retention part 14 through a liquid path. A bubble discharging tube 19 may be optionally provided, if desired. The liquid droplet injection unit 2A is provided on the top surface of the toner particle formation part 3 by a support member, not shown, that is attached to the flow path member 15. Alternatively, the liquid droplet injection unit 2A may be provided on a side surface or the bottom surface of the toner particle formation part 3.

In general, the smaller the frequency of the generated vibration, the larger the size of the vibration unit 13. The vibration unit 13 may be directly drilled to form a retention part according to a required frequency. It may be also possible to vibrate the retention part entirely. In this case, a surface to which a thin film including multiple nozzles is attached is regarded as a vibrating surface.

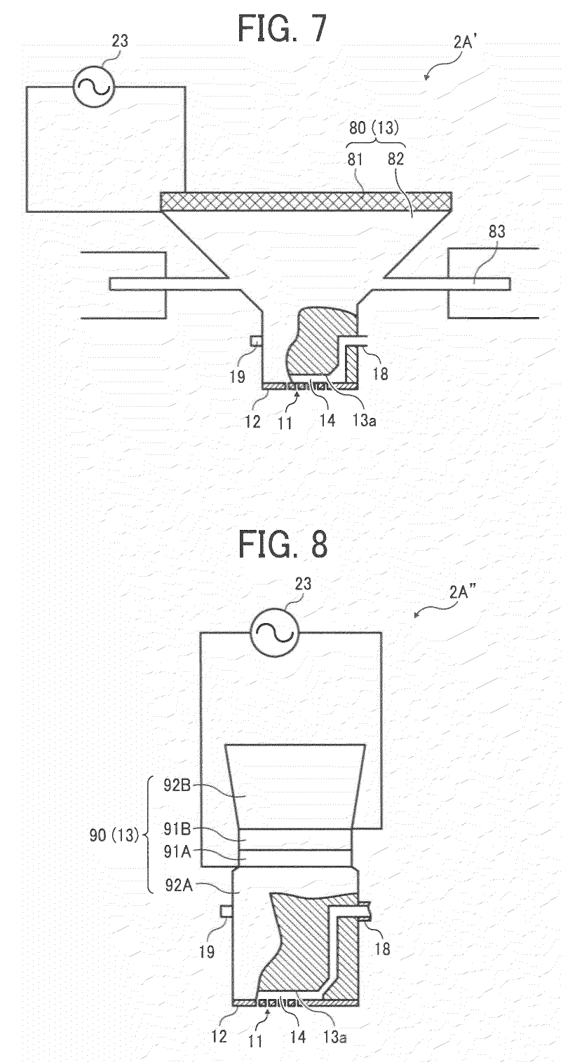

FIGS. 7 and 8 are schematic views illustrating other exemplary embodiments of liquid droplet injection units 2A′ and 2A″, respectively.

Referring to FIG. 7, the liquid droplet injection unit 2A′ includes a horn vibrator 80 (i.e., the vibration unit 13) that includes a piezoelectric substance 81 serving as a vibration generating part and a horn 82 serving as a vibration amplifying part. A retention part 14 is formed inside the horn 82. The liquid droplet injection unit 2A′ is preferably provided on a side surface of the toner particle formation part 3 by a flange 83 that is integrated with the horn 82. In view of reducing vibration loss, the liquid droplet injection unit 2A′ may be fixed by an elastic body, not shown.

Referring to FIG. 8, the liquid droplet injection unit 2A″ includes a bolted Langevin vibrator 90 (i.e., the vibration unit 13) that includes piezoelectric substances 91A and 91B serving as a vibration generating part and horns 92A and 92B serving as a vibration amplifying part. The vibration generating part (91A and 91B) and the vibration amplifying part (92A and 92B) are tightly fixed together mechanically. A retention part 14 is formed inside the horn 92A. The size of the vibrator may be large according to a required frequency. In this case, as illustrated, a liquid flow path and the retention part 14 may be provided inside the vibrator and a metallic thin film 12 including multiple nozzles 11 may be attached thereto.

Referring back to FIG. 1, only one liquid droplet injection unit 2A is provided on the toner particle formation part 3. From the viewpoint of productivity, it is more preferable that multiple liquid droplet injection units 2A are provided on the top surface of the toner particle formation part 3. The number of the liquid droplet injection unit 2A is preferably from 100 to 1,000 from the viewpoint of controllability. In this case, the toner components liquid 10 is supplied from the raw material container 7 to each retention parts 14 in each liquid droplet injection units 2A through the pipe 8. The toner components liquid 10 may be self-supplied from the raw material container 7 when the liquid droplet injection unit 2A discharges liquid droplets 31. Alternatively, the toner components liquid 10 may be supplementarily supplied by the pump 9.

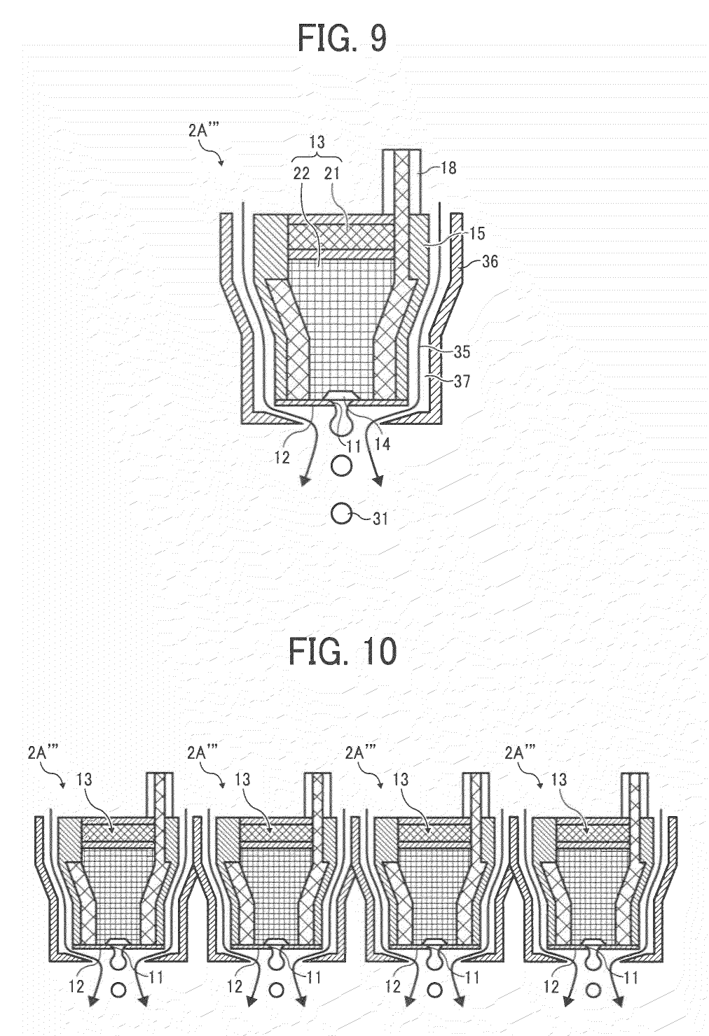

FIG. 9 is a schematic cross-sectional view illustrating another exemplary embodiment of a liquid droplet injection unit 2A′″.

The liquid droplet injection unit 2A′″ includes a horn vibrator serving as the vibration unit 13. A flow path member 15 is provided surrounding the vibration unit 13. The flow path member 15 is configured to supply the toner components liquid 10. A retention part 14 is provided inside a horn 22 so that the retention part 14 faces a thin film 12. An airflow path forming member 36 is provided surrounding the flow path member 15 so that an airflow path 37 is formed. An airflow 35 flows in the airflow path 37. To simplify the drawing, only one nozzle 11 is illustrated in FIG. 9, however, the thin film 12 includes multiple nozzles actually.

As illustrated in FIG. 10, multiple liquid droplet injection units 2A′″ may be provided on the top surface of the toner particle formation part 3. From the viewpoint of productivity and controllability, the number of the liquid droplet injection units 2A′″ is preferably from 100 to 1,000.

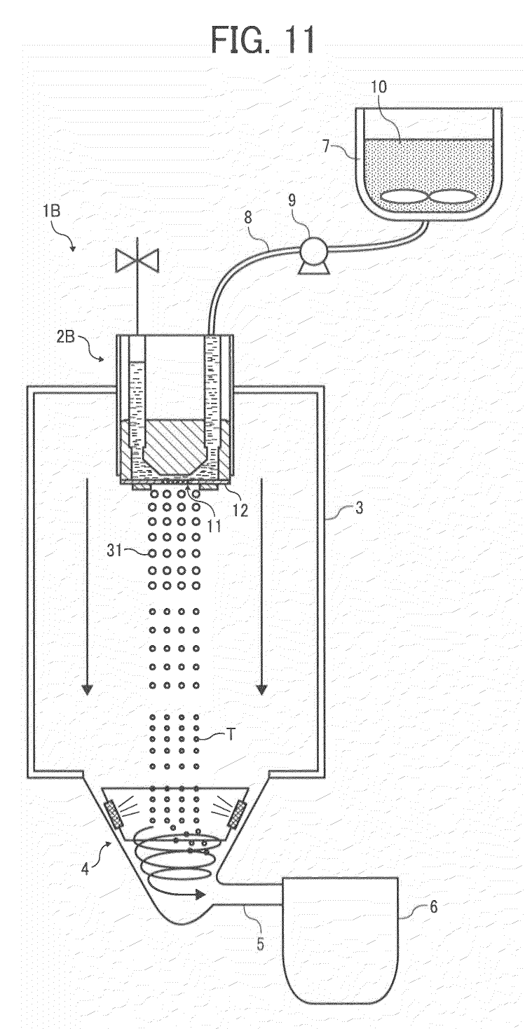

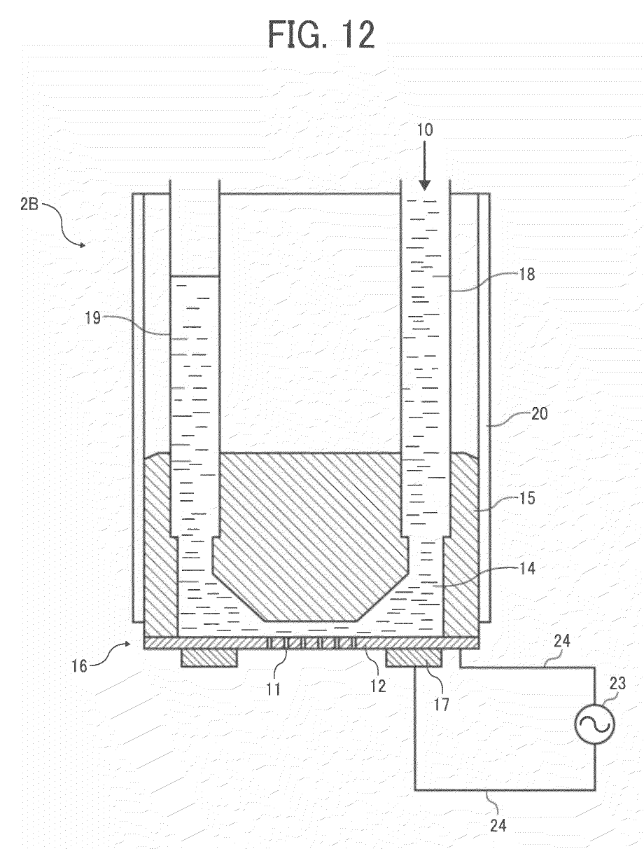

FIG. 11 is a schematic view illustrating another exemplary embodiment of a toner production apparatus 1B including a ring vibrator. The toner production apparatus 1B includes a liquid droplet injection unit 2B. FIG. 12 is a schematic cross-sectional view illustrating an embodiment of the liquid droplet injection unit 2B.

Referring to FIG. 12, the liquid droplet injection unit 2B includes a liquid droplet forming unit 16 and a flow path member 15. The liquid droplet forming unit 16 is configured to discharge a toner components liquid 10 comprising a resin and a colorant to form liquid droplets thereof. The flow path member 15 is configured to form a liquid flow path and supplies the toner components liquid 10 to a retention part 14.

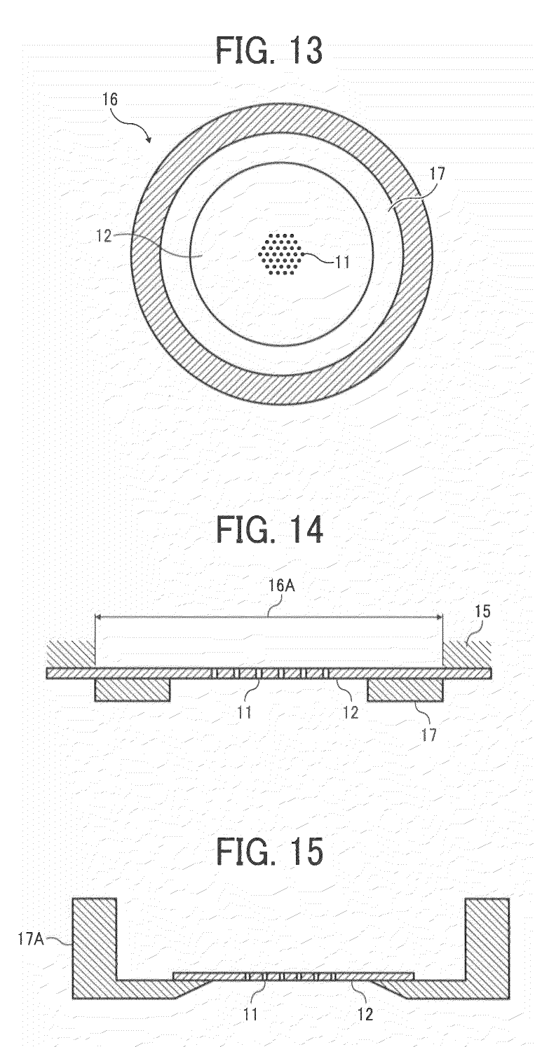

FIG. 13 is a schematic bottom view illustrating an embodiment of the liquid droplet forming unit 16. FIG. 14 is a schematic cross-sectional view illustrating an embodiment of the liquid droplet forming unit 16.

The liquid droplet forming unit 16 includes a thin film 12 and a ring-shaped vibration generating unit 17. The thin film 12 includes multiple nozzles 11. The ring-shaped vibration generating unit 17 is configured to vibrate the thin film 12. The outermost portion (shaded portion in FIG. 13) of the thin film 12 is fixed to the flow path member 15 with solder or a binder resin which does not dissolve in the toner components liquid 10. The ring-shaped vibration generating unit 17 is provided on a periphery within a transformable region 16A (i.e., a region which is not fixed to the flow path member 15) of the thin film 12. Upon application of a driving voltage (driving signal) having a specific frequency from a driving signal generating source 23 through a communication member 24, the ring-shaped vibration generating unit 17 generates flexural vibration, for example.

FIG. 15 is a schematic cross-sectional view illustrating another embodiment of the liquid droplet forming unit 16.

Referring to FIG. 14, the ring-shaped vibration generating unit 17 is provided on a periphery within the transformable region 16A of the thin film 12. On the other hand, referring to FIG. 15, a ring-shaped vibration generating unit 17A supports a periphery of the thin film 12. Comparing FIG. 14 and FIG. 15, the amount of displacement of the thin film 12 may be larger in the embodiment of FIG. 14 than in the embodiment of FIG. 15. Therefore, in the embodiment of FIG. 14, multiple nozzles 11 can be provided on a relatively large area (having a diameter of 1 mm or more). As a result, a greater amount of liquid droplets can be simultaneously and reliably discharged from the multiple nozzles 11.

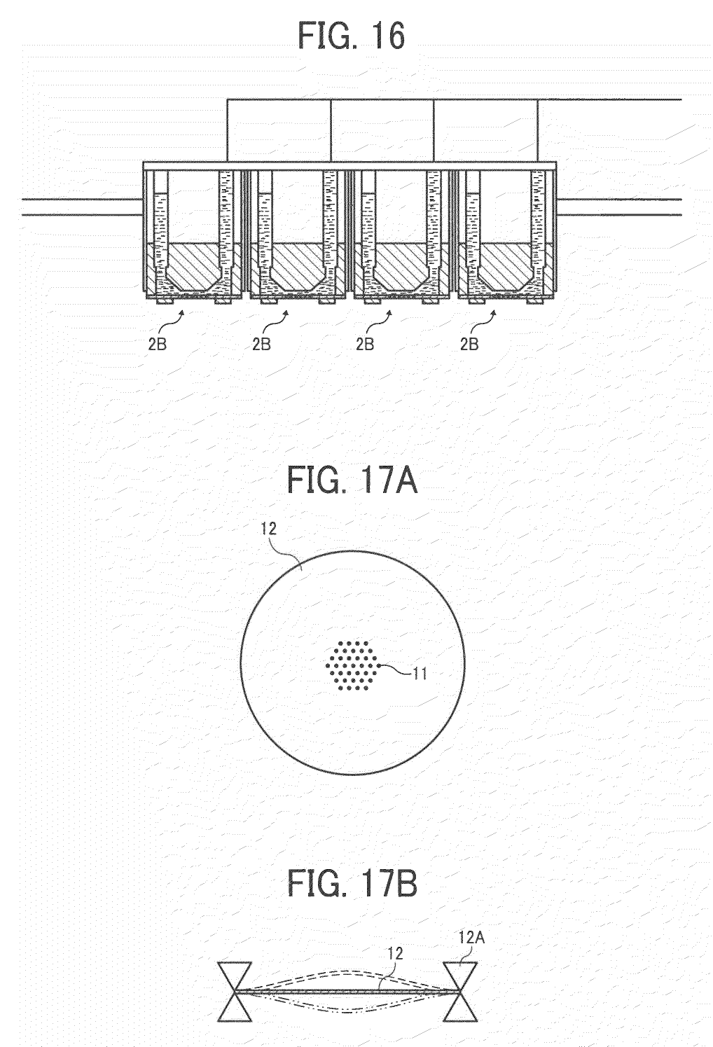

Referring back to FIG. 11, only one liquid droplet injection unit 2B is provided on the toner particle formation part 3. From the viewpoint of productivity, as illustrated in FIG. 16, multiple liquid droplet injection units 2B may be preferably provided on the top surface of the toner particle formation part 3. The number of the liquid droplet injection unit 2B is preferably from 100 to 1,000 from the viewpoint of controllability. The toner components liquid 10 is supplied from the raw material container 7 to each liquid droplet injection units 2B through the pipe 8.

A mechanism of formation of liquid droplets by the liquid droplet injection units 2A and 2B is described below.

In the liquid droplet injection unit 2A or 2B, a vibration generated by the vibration unit 13 is propagated to the thin film 12 so that the thin film 12 periodically vibrates. The thin film 12 includes the multiple nozzles 11 that are provided within a relatively large area (having a diameter of 1 mm or more). The thin film 12 faces the retention part 14. Liquid droplets are reliably discharged from the multiple nozzles 11 by periodical vibration of the thin film 12.

FIGS. 17A and 17B are schematic bottom and cross-sectional views, respectively, illustrating an exemplary embodiment of the thin film 12.

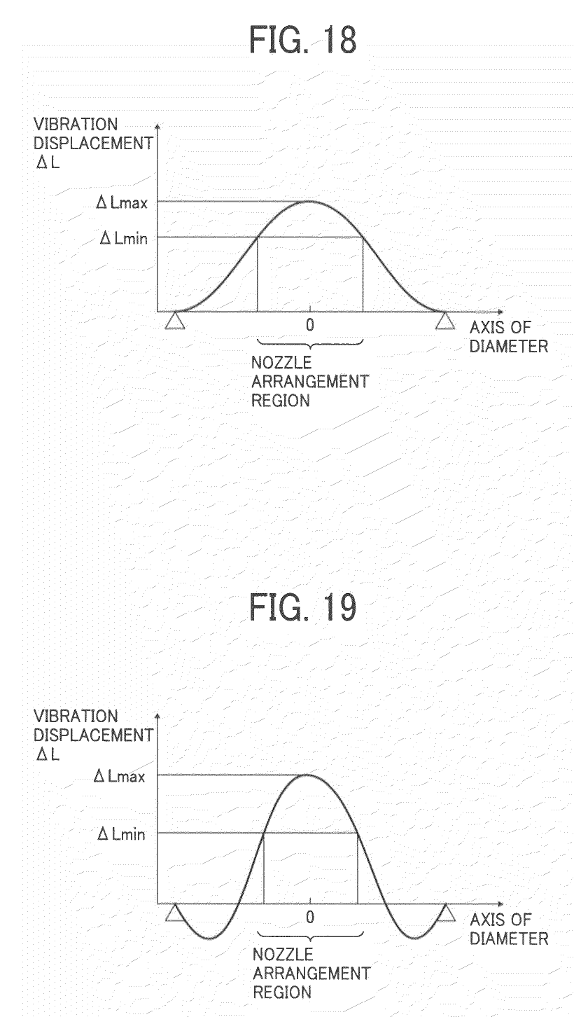

When the thin film 12 is a simple circular film and a periphery 12A thereof is fixed, the thin film 12 may vibrate at a fundamental vibration mode as shown in FIG. 18. FIG. 18 is a cross-sectional view of the thin film 12 illustrating the fundamental vibration mode. The thin film 12 periodically vibrates in a vertical direction while the center O displaces at the maximum displacement (ΔLmax) and the periphery forms a node.

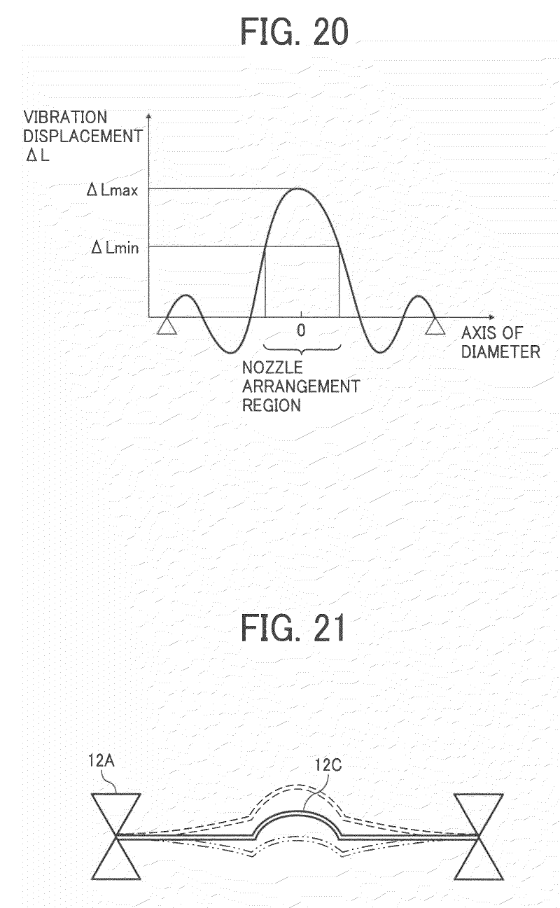

The thin film 12 may also vibrate at a higher mode as illustrated in FIGS. 19 and 20. In these cases, one or more nodes are concentrically formed within the thin film 12. The thin film 12 may axisymmetrically transform.

The thin film 12 may be a thin film 12C having a convexity on the center portion thereof as illustrated in FIG. 21. In this case, a direction of movement of liquid droplets and the amount of amplitude can be more controllable.

When the circular thin film 12 vibrates, a sound pressure P_{ac} generates in the toner components liquid 10 in the vicinity of the nozzles 11. The sound pressure P_{ac} is proportional to a vibration rate Vₘ of the thin film 12. It is known that the sound pressure P_{ac} generates as a counter reaction of a radiation impedance Zᵣ of a medium (i.e., the toner components liquid 10). The sound pressure P_{ac} is defined by the following equation:

P_{ac}(r,t)=Zᵣ·Vₘ(r,t) (1)

The vibration rate Vₘ is a function of time (t) because it periodically varies with time. Periodic variations such as sine waves and square waves may be formed. The vibration rate Vₘ is also a function of position because the vibration displacement varies by location. Since the thin film 12 axisymmetrically vibrates, the vibration rate Vₘ is substantially a function of coordinates of radius (r).

Upon generation of a sound pressure P_{ac} that is proportional to the vibration rate Vₘ of the thin film 12, the toner components liquid 10 is discharged to a gas phase according to periodical variation of the sound pressure P_{ac}.

The toner components liquid 10 periodically discharged to a gas phase are formed into spherical particles due to the difference in surface tension between the liquid phase and the gas phase. Thus, liquid droplets are periodically formed.

In order to reliably form liquid droplets, the vibration frequency of the thin film 12 is preferably from 20 kHZ to 2.0 MHz, and more preferably from 50 kHz to 500 kHz. When the frequency is 20 kHz or more, particles of colorants and waxes may be finely dispersed in the toner components liquid 10.

When the amount of displacement of the sound pressure is 10 kPa or more, particles of colorants and waxes may be more finely dispersed in the toner components liquid 10.

The larger the vibration displacement near the nozzles 11 of the thin film 12, the larger the diameter of liquid droplets discharged from the nozzles 11. When the vibration displacement is too small, small liquid droplets or no liquid droplet may be formed. In order to reduce variations in size of liquid droplets, the nozzles 11 are preferably provided on appropriate positions.

Referring to FIGS. 18 to 20, the nozzles 11 are preferably provided on a region in which the ratio (ΔLmax/ΔLmin) of the maximum vibration displacement (ΔLmax) to the minimum vibration displacement (ΔLmin) is 2.0 or less. In this case, the size of liquid droplets may be uniform and the resultant toner can provide high quality images.

When the toner components liquid 10 has a viscosity of 20 mPa·s or less and a surface tension of from 20 to 75 mN/m, undesired small liquid droplets are produced in the same region. Therefore, the displacement amount of the sound pressure needs to be 500 kPa or less, and more preferably 100 kPa or less.

To reliably form extremely uniform-sized liquid droplets, the thin film 12 is preferably formed from a metal plate having a thickness of from 5 to 500 μm and the nozzles 11 preferably have an aperture diameter of from 3 to 30 μm. The aperture diameter represents the diameter when the nozzle 11 is a perfect circle, and the minor diameter when the nozzle 11 is an ellipse. The number of nozzles 11 is preferably from 2 to 3,000.

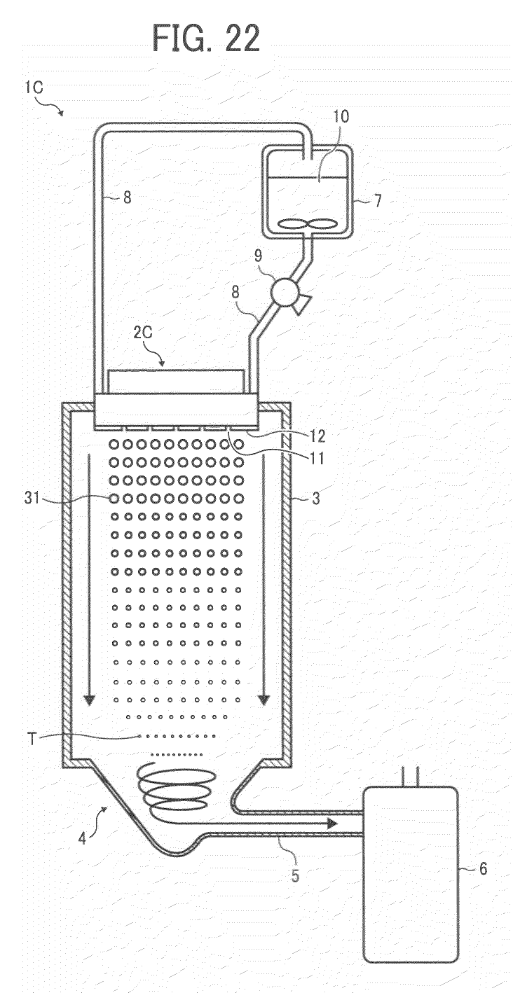

FIG. 22 is a schematic view illustrating another exemplary embodiment of a toner production apparatus 1C employing a liquid resonance method. The toner production apparatus 1C forms liquid droplets by resonance of liquid, while the toner production apparatus 1A and 1B forms liquid droplets by vertical vibration of a thin film including multiple nozzles.

Accordingly, the toner production apparatus 1C includes a thin film having an appropriate strength so as not to vibrate. In the present embodiment, suitable materials for the thin film include silicon and silicon oxides, for example. The thin film is preferably formed from a silicon substrate or a SOI (i.e., silicon on insulator) substrate, in view of forming nozzles thereon. When the thin film is relatively thick, nozzles preferably have a two-step cross section, to improve discharging performance.

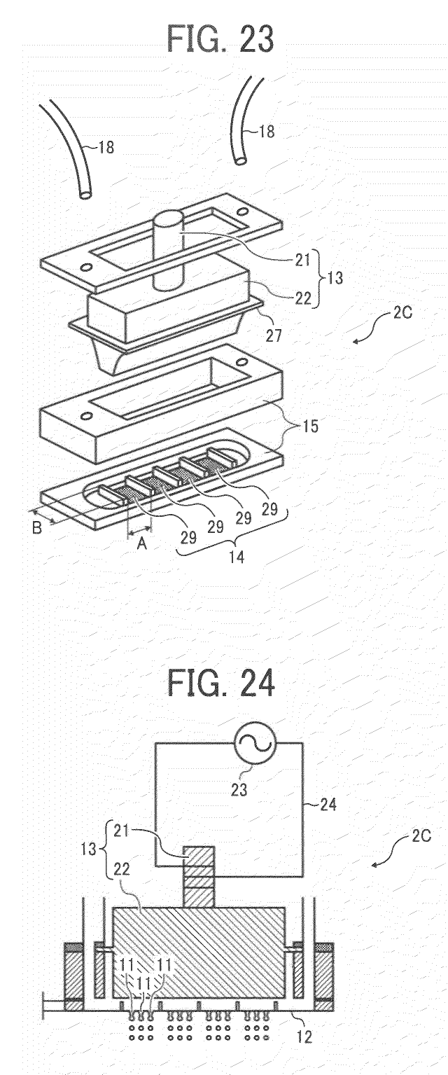

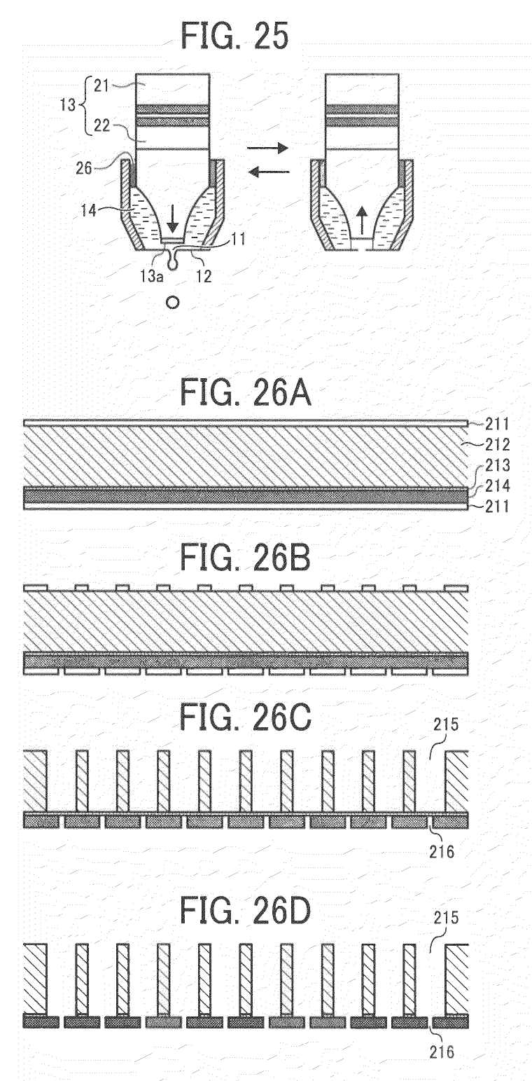

FIG. 23 is an exploded view of an embodiment of the liquid droplet injection unit 2C. FIG. 24 is a schematic cross-sectional view illustrating an embodiment of the liquid droplet injection unit 2C. FIG. 25 is a schematic view of an example of formation of liquid droplets in the liquid droplet injection unit 2C.

Referring to FIGS. 23 to 25, the liquid droplet injection unit 2C includes a thin film 12, a vibration unit 13, and a flow path member 15. The thin film 12 includes multiple nozzles 11. The flow path member 15 forms a retention part 14 that is configured to retain the toner components liquid 10. The vibration unit 13 and a wall of the retention part 14 are preferably separated by a vibration separating member 26. Alternatively, the vibration unit 13 may be directly fixed to a wall by a node portion 27 of the vibration unit 13. The node portion 27 vibrates at a small vibration amplitude. The toner components liquid 10 is supplied to the retention part 14 through a liquid supplying tube 18.

Exemplary embodiments of the vibration unit 13 and the vibration amplifying unit 22 include the above-described embodiments for the toner production apparatuses 1A and 1B.

Walls of the retention part 14 may be made of materials which do not dissolve in or denaturalize the toner components liquid 10, such as metals, ceramics, and plastics, for example. The retention part 14 is divided into multiple retention regions 29 by multiple walls, so that vibration of several ten kHz is evenly applied to each retention regions 29 and resonance frequency is increased.

Referring to FIG. 25, when a vibration of a vibrating surface 13a that is generated by the vibration unit 13 is transmitted to the toner components liquid 10 in the retention part 14, liquid resonance occurs in the toner components liquid 10. The toner components liquid 10 is reliably discharged from the multiple nozzles 11 provided on the thin film 12 upon application of even pressure, without deposition of dispersoids in the toner components liquid 10 on the thin film 12.

FIGS. 26A to 26D are schematic views illustrating an exemplary method of forming nozzles having a two-step cross section. First, as illustrated in FIG. 26A, both sides of a silicon substrate are coated with a resist 211. Next, as illustrated in FIG. 26B, the silicon substrate is covered with photomasks including nozzle patterns and exposed to ultraviolet ray, to form nozzle patterns on the resists 211. Next, as illustrated in FIG. 26C, a support layer 212 side of the silicon substrate is subjected to anisotropic etching using ICP electrical discharge so that first nozzles 215 are formed. Subsequently, an active layer 214 side of the silicon substrate is subjected to anisotropic etching so that second nozzles 216 are formed. Finally, as illustrated in FIG. 26D, a dielectric layer 213 is removed by a hydrofluoric etching liquid to form two-step nozzles. Suitable silicon substrates include SOI substrates and single-layer silicon substrates. The depths of the first and second nozzles can be controlled by controlling the etching time.

To reliably form extremely uniform-sized liquid droplets, in the present embodiment, the thin film 12 preferably has a thickness of from 30 to 1,000 μm and the nozzles 11preferably have an aperture diameter of from 4 to 15 μm, for example. The aperture diameter represents the diameter when the nozzle 11 is a perfect circle, and the minor diameter when the nozzle 11 is an ellipse.

Exemplary embodiments of the vibration unit 13 include multi-layer PZT and a combination of an ultrasonic vibrator and an ultrasonic horn, for example, which are capable of applying mechanical ultrasonic vibration with a large amplitude to the toner components liquid 10.

A vibration generated by the vibration unit 13 is transmitted to the toner components liquid 10 in the retention part 14, and liquid resonance occurs in the toner components liquid 10 in the retention part 14. The toner components liquid 10 is evenly discharged from the multiple nozzles 11 provided on the thin film 12 upon application of even pressure due to the liquid resonance, without deposition of dispersoids in the toner components liquid 10 on the thin film 12.

In a case in which the thin film 12 including the multiple nozzles 11 is mechanically vibrated, there may be a disadvantage that the multiple nozzles 11 vibrate unevenly, especially when the thin film 12 has a large area. As a result, the discharged liquid droplets may have a wide size distribution. By comparison, in a case in which the toner components liquid 10 is discharged due to liquid resonance, the discharged liquid droplets may have a narrow size distribution because pressure is evenly applied to each nozzles 11.

The liquid droplets are subjected to a drying process to remove the solvents from the liquid droplets. For example, the liquid droplets may be released into a gas such as heated dried nitrogen gas. The liquid droplets may be further subjected to a secondary drying process such as fluidized bed drying and vacuum drying, if desired.

The above-described exemplary spraying methods and vibration injection methods provides toners having both good chargeability and non-spherical shape that is easily removable by blade members. It was apparent from a TOF-SIMS analysis that a polycondensation reaction product of a phenol with an aldehyde (i.e., charge controlling agent) locally presents on the surface of the toner, because the strength specific to binder resin drastically decreases as the added amount of the polycondensation reaction product of a phenol with an aldehyde increases. Accordingly, the toner of the present invention produced by exemplary spraying methods and vibration injection methods has better chargeability than conventional pulverization toners.

Because of locally existing on the surface of toner, the charge controlling agents may be dried at first. Subsequently, the solvent is dried while forming convexities on the surface of the toner. Thus, the resultant toner may have a non-spherical shape.

Vibration injection methods provide much narrower particle diameter distribution compared to spraying methods.

### (Image Forming Method and Image Forming Apparatus)

An exemplary image forming method includes an electrostatic latent image forming process, a developing process, a transfer process, and a fixing process, and optionally includes a decharging process, a cleaning process, a recycle process, and a control process. In the electrostatic latent image forming process, an electrostatic latent image is formed on an electrostatic latent image bearing member. In the developing process, the electrostatic latent image is developed with an exemplary toner of the present invention to form a toner image. In the transfer process, the toner image is transferred onto a recording medium. In the fixing process, the toner image is fixed on the recording medium upon application of heat and pressure from a roller-shaped or belt-shaped fixing member.

An exemplary image forming apparatus includes an electrostatic latent image bearing member, an electrostatic latent image forming device, a developing device, a transfer device, and a fixing device, and optionally includes a decharging device, a cleaning device, a recycle device, and a control device. The electrostatic latent image forming device is configured to form an electrostatic latent image on the electrostatic latent image bearing member. The developing device is configured to develop the electrostatic latent image with an exemplary toner of the present invention to form a toner image. The transfer device is configured to transfer the toner image onto a recording medium. The fixing device is configured to fix the toner image on the recording medium upon application of heat and pressure from a roller-shaped or belt-shaped fixing member.

In the electrostatic latent image forming process, an electrostatic latent image is formed on an electrostatic latent image bearing member.

The material, shape, structure, and size of the electrostatic latent image bearing member are not particularly limited, however, a drum-shaped electrostatic latent image bearing member is preferable. Exemplary embodiments of the electrostatic latent image bearing member include, but are not limited to, organic photoreceptors and inorganic photoreceptors including amorphous silicon, selenium, etc.

The electrostatic latent image forming device may form an electrostatic latent image by uniformly charging a surface of the electrostatic latent image bearing member, and subsequently irradiating the charged surface of the electrostatic latent image bearing member with a light beam containing image information. The electrostatic latent image forming device may include a charger for uniformly charging a surface of the electrostatic latent image bearing member and an irradiator for irradiating the charged surface of the electrostatic latent image bearing member with a light beam containing image information, for example.

The charger may charge a surface of the electrostatic latent image bearing member by applying a voltage thereto.

The charger may be, for example, contact chargers including a conductive or semi-conductive roller, brush, film, or rubber blade, or non-contact chargers using corona discharge such as corotron and scorotron.

The irradiator may irradiate the charged surface of the electrostatic latent image bearing member with a light beam containing image information.

The irradiator may be, for example, irradiators using a radiation optical system, a rod lens array, a laser optical system, or a liquid crystal shutter optical system.

In the present embodiment, the electrostatic latent image bearing member may be irradiated with a light beam containing image information from the backside thereof.

In the developing process, the electrostatic latent image is developed with the toner or developer of the present invention to form a toner image.

The developing device may form the toner image by developing the electrostatic latent image with the toner or developer of the present invention.

The developing device may be, for example, a developing device containing the toner or developer of the present invention, preferably contained in a container, and capable of supplying the toner or developer to the electrostatic latent image while contacting or without contacting the electrostatic latent image.

The developing device may be either a single-color developing device or a multi-color developing device. The developing device may include an agitator for triboelectrically charging the toner or developer, and a rotatable magnetic roller.

In the developing device, the toner and the carrier are mixed so that the toner is charged. The developer (i.e., the toner and the carrier) forms magnetic brushes on the surface of the rotatable magnetic roller. Since the magnetic roller is provided adjacent to the electrostatic latent image bearing member, a part of the toner that forms the magnetic brushes on the magnetic roller is moved to the surface of the electrostatic latent image bearing member due to an electric attraction force. As a result, the electrostatic latent image is developed with the toner and a toner image is formed on the surface of the electrostatic latent image bearing member.

The developer may be either a one-component developer or a two-component developer. The developer includes the toner of the present invention.

In the transfer process, a toner image is transferred onto a recording medium. It is preferable that the transfer process includes a primary transfer process in which a toner image is transferred onto an intermediate transfer member and a secondary transfer process in which the toner image is transferred from the intermediate transfer member onto a recording medium. It is more preferable that the transfer process includes a primary transfer process in which two or more monochrome toner images, preferably in full color, are transferred onto the intermediate transfer member to form a composite toner image and a secondary transfer process in which the composite toner image is transferred onto the recording medium.

The transfer process may be performed by charging a toner image formed on the electrostatic latent image bearing member by the transfer device such as a transfer charger. The transfer device preferably includes a primary transfer device for transferring monochrome toner images onto an intermediate transfer member to form a composite toner image and a secondary transfer device for transferring the composite toner image onto a recording medium. The intermediate transfer member may be, for example, a transfer belt.

The transfer device (such as the primary transfer device and the secondary transfer device) preferably includes a transferrer to separate the toner image from the electrostatic latent image bearing member onto a recording medium. The number of the transfer device may be 1 or more.

The transferrer may be, for example, a corona transferrer using corona discharge, a transfer belt, a transfer roller, a pressing transfer roller, or an adhesion transferrer.

The recording medium may be, for example, a recording paper.

In the fixing process, the toner image transferred onto a recording medium is fixed thereon by the fixing device. Each of monochrome toner images may be independently fixed on the recording medium. Alternatively, a composite toner image in which monochrome toner images are superimposed on one another may be fixed at once.

The fixing device may be, for example, heat and pressure applying devices. The heat and pressure applying device may be, for example, a combination of a heating roller and a pressing roller, a combination of a heating roller, a pressing roller, and a seamless belt.

A heating target may be typically heated to a temperature of from 120 to 200° C. Optical fixing devices may be used alone or in combination with the above-described fixing device in the fixing process.

In the decharging process, charges remaining on the electrostatic latent image bearing member are removed by applying a decharging bias to the electrostatic latent image bearing member. The decharging process is preferably performed by a decharging device. The decharging device may be, for example, a decharging lamp.

In the cleaning process, toner particles remaining on the electrostatic latent image bearing member are removed by a cleaning device. The cleaning device may be, for example, a magnetic brush cleaner, an electrostatic brush cleaner, a magnetic roller cleaner, a blade cleaner, a brush cleaner, or a web cleaner.

In the recycle process, the toner particles removed by the cleaning device are recycled by a recycle device. The recycle device may be, for example, feeding devices.

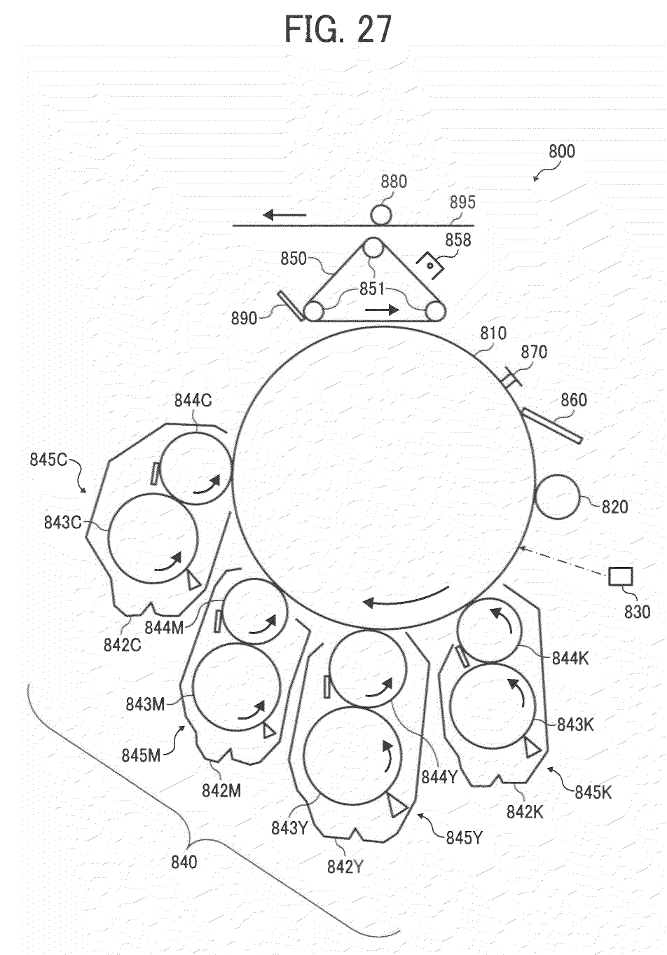

FIG. 27 is a schematic view illustrating an exemplary embodiment of an image forming apparatus. An image forming apparatus 800 includes a photoreceptor 810 serving as the electrostatic latent image bearing member, a charging roller 820 serving as the charger, a light irradiator 830 serving as the irradiator, a developing device 840 including developing units 845K, 845Y, 845M, and 845C each serving as the developing device, an intermediate transfer member 850, a cleaning device 860 including a cleaning blade serving as the cleaning device, and a decharging lamp 870 serving as the discharging device.

The intermediate transfer member 850 is an endless belt. The intermediate transfer member 850 is stretched taut by three rollers 851 to move endlessly in a direction indicated by an arrow in FIG. 27. Some of the rollers 851 have a function of applying a transfer bias to the intermediate transfer member 850 in the primary transfer process so that a toner image is transferred onto the intermediate transfer member 850.

A cleaning device 890 including a cleaning blade is provided adjacent to the intermediate transfer member 850. A transfer roller 880 serving as the transfer device is provided facing the intermediate transfer member 850. The transfer roller 880 is capable of applying a transfer bias to a transfer paper 895 in the secondary transfer process so that a toner image is transferred onto the transfer paper 95.

A corona charger 858 is configured to charge the toner image on the intermediate transfer member 850. The corona charger 858 is provided on a downstream side from a contact point of the intermediate transfer member 850 with the photoreceptor 810, and an upstream side from a contact point of the intermediate transfer member 850 with the transfer paper 895, relative to the direction of rotation of the intermediate transfer member 850.

The developing units 845K, 845Y, 845M, and 845C include developer containers 842K, 842Y, 842M, and 842C, developer feeding rollers 843K, 843Y, 843M, and 843C, and developing rollers 844K, 844Y, 844M, and 844C, respectively.

In the image forming apparatus 800, the photoreceptor 810 is evenly charged by the charging roller 820, and subsequently the light irradiator 830 irradiates the photoreceptor 810 with a light beam containing image information to form an electrostatic latent image thereon. The electrostatic latent image formed on the photoreceptor 810 is developed with toners supplied from the developing units 845K, 845Y, 845M, and 845C, to form a toner image. The toner image is transferred onto the intermediate transfer member 850 due to a bias applied from some of the rollers 851 (i.e., the primary transfer process), and subsequently transferred onto the transfer paper 895 (i.e., the secondary transfer process). Toner particles remaining on the photoreceptor 810 are removed by the cleaning device 860, and the photoreceptor 810 is decharged by the decharging lamp 870.

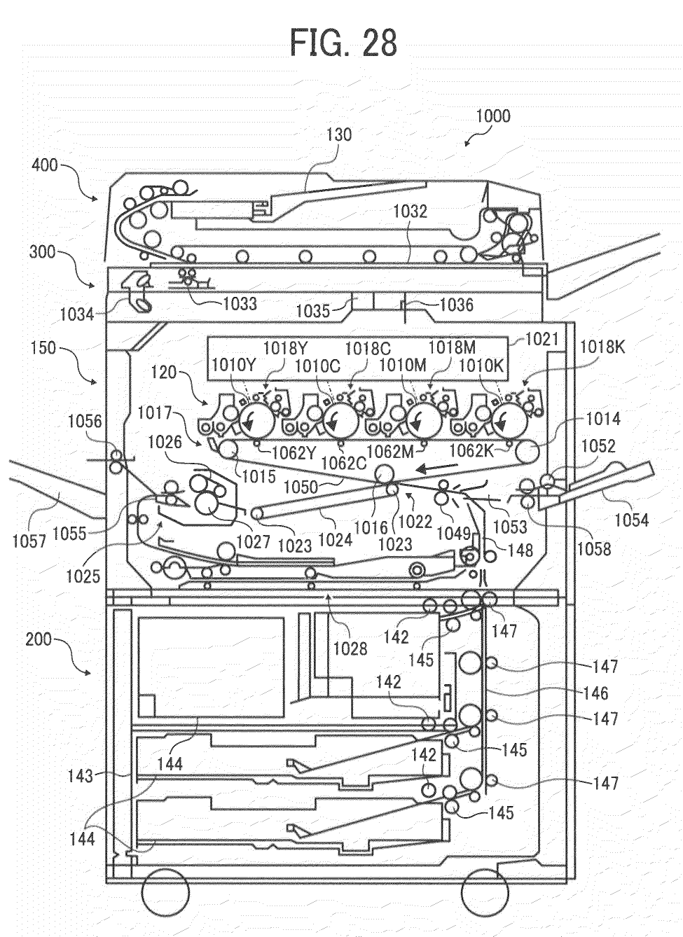

FIG. 28 is a schematic view illustrating another exemplary embodiment of an image forming apparatus. An image forming apparatus 1000 includes a main body 150, a paper feed table 200, a scanner 300, and an automatic document feeder (ADF) 400.

The main body 150 includes an intermediate transfer member 1050 that is an endless belt in the center thereof. The intermediate transfer member 1050 is stretched taut by support rollers 1014, 1015, and 1016 and rotates clockwise in FIG. 28. An intermediate transfer member cleaning device 1017 for removing residual toner particles remaining on the intermediate transfer member 1050 is provided adjacent to the support roller 1015. Image forming units 1018Y, 1018C, 1018M, and 1018K are laterally arranged along the intermediate transfer member 1050 between the support rollers 1014 and 1015. A tandem image forming device 120 is comprised of the image forming units 1018Y, 1018C, 1018M, and 1018K. An irradiator 1021 is provided above the tandem image forming device 120. A secondary transfer device 1022 is provided on the opposite side of the tandem image forming device 120 relative to the intermediate transfer member 1050. The secondary transfer device 1022 includes support rollers 1023 and a secondary transfer belt 1024 that is an endless belt. The secondary transfer belt 1024 is stretched taut by the support rollers 1023. A sheet of transfer paper on the secondary transfer belt 1024 can be in contact with the intermediate transfer member 1050. A fixing device 1025 is provided adjacent to the secondary transfer device 1022. The fixing device 1025 includes a fixing belt 1026 that is an endless belt and a pressing roller 1027 that is pressed against the fixing belt 1026.

A sheet reversing device 1028 is provided adjacent to the secondary transfer device 1022 and the fixing device 1025. The sheet reversing device 1028 is configured to reverse sheets so that images are recorded on both sides of the sheets.

To make a full-color copy, a document may be set on a document table 130 of the automatic document feeder 400. Alternatively, a document may be set on a contact glass 1032 of the scanner 300 while lifting up the automatic document feeder 400, and then the document is hold down by the automatic document feeder 400.

Upon pressing of a switch, not shown, in a case in which a document is set on the contact glass 1032, the scanner 300 immediately starts driving so that a first runner 1033 and a second runner 1034 start moving. In a case in which a document is set on the document table 130, the scanner 300 starts driving after the document is fed onto the contact glass 1032. The first runner 1033 directs a light beam to the document, and reflects a reflected light beam from the document toward the second runner 1034. A mirror in the second runner 1034 reflects the reflected light beam toward an imaging lens 1035. The light beam passed through the imaging lens 1035 is then received by a reading sensor 1036 and image information of black, yellow, magenta, and cyan is read.

The image information of black, yellow, magenta, and cyan is transmitted to the respective image forming units 1018Y, 1018C, 1018M, and 1018K to form toner images of black, yellow, magenta, and cyan, respectively.

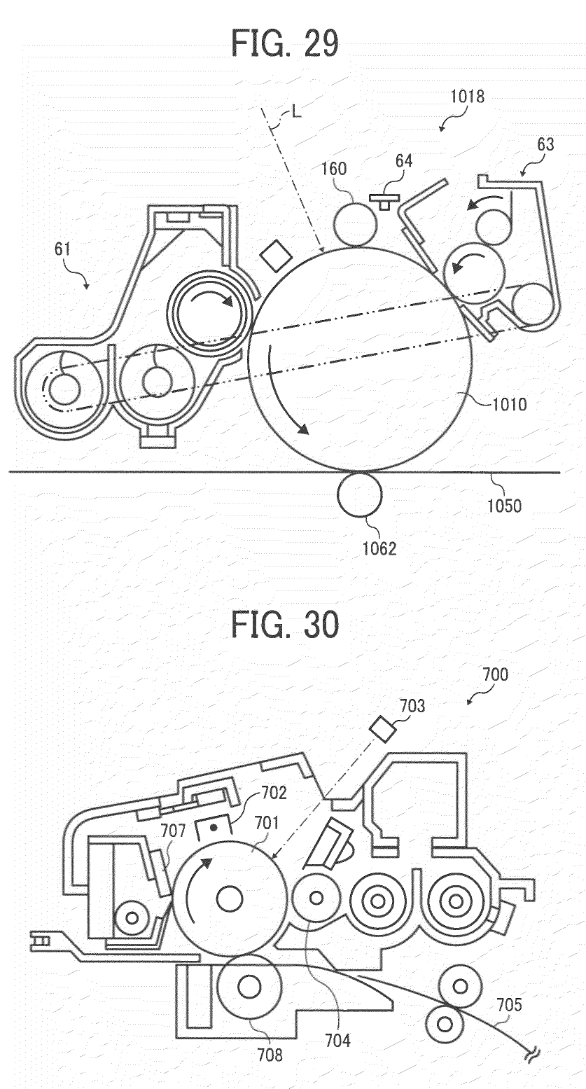

FIG. 29 is a schematic view illustrating an embodiment of each of the image forming units 1018Y, 1018C, 1018M, and 1018K. Since the image forming units 1018Y, 1018C, 1018M, and 1018K have the same configuration, only one image forming unit is illustrated in FIG. 29. Symbols Y, C, M and K, which represent each of the colors, are omitted from the reference number. The image forming unit 1018 includes a photoreceptor 1010, a charger 160, an irradiator, not shown, a developing device 61, a transfer charger 1062, a cleaning device 63, and a decharging device 64. The charger 160 is configured to uniformly charge the photoreceptor 1010. The irradiator is configured to irradiate the charged photoreceptor 1010 with a light beam L containing image information to form an electrostatic latent image corresponding to each color. The developing device 61 is configured to develop the electrostatic latent image with a toner to form a toner image. The transfer charger 1062 is configured to transfer the toner image onto the intermediate transfer member 1050. The yellow, cyan, magenta, and black toner images formed on the respective photoreceptors 1010Y, 1010C, 1010M, and 1010K are independently transferred onto the intermediate transfer member 1050 in the primary transfer process and superimposed thereon one another so that a composite full-color toner image is formed.

On the other hand, upon pressing of the switch, one of paper feed rollers 142 starts rotating in the paper feed table 200 so that a sheet is fed from one of paper feed cassettes 144 in a paper bank 143. The sheet is separated by one of separation rollers 145 and fed to a paper feed path 146. Feed rollers 147 feed the sheet to a paper feed path 148 in the main body 150. The sheet is stopped by a registration roller 1049. Alternatively, a sheet may be provided from a manual feed tray 1054 by rotating a paper feed roller 1052. The sheet may be separated by a separation roller 1058 to be fed to a manual paper feed path 1053 and stopped by the registration roller 1049. The registration roller 49 is typically grounded, however, a bias may be applied thereto for the purpose of removing paper powders.

The registration roller 1049 feeds the sheet to between the intermediate transfer member 1050 and the secondary transfer device 1022 in synchronization with an entry of the composite full-color toner image thereto. Thus, the composite full-color toner image (hereinafter the “toner image”) is transferred onto the sheet. The intermediate transfer member cleaning device 1017 removes residual toner particles remaining on the intermediate transfer member 1050.

The secondary transfer device 1022 transfers the sheet having the toner image thereon to the fixing device 1025. The toner image is fixed on the sheet by application of heat and pressure in the fixing device 1025. The sheet on which the toner image is fixed is switched by a switch pick 1055 so as to be discharged onto a discharge tray 1057 by rotating a discharge roller 1056. Alternatively, the sheet on which the toner image is fixed may be switched by a switch pick 1055 so as to be fed to the sheet reversing device 1028. In this case, the sheet may be fed to the transfer area again so that an image is formed on the back side of the sheet. The sheet having images on both sides thereof may be discharged onto the discharge tray 1057 by rotating the discharge roller 1056.

### (Process Cartridge)

An exemplary process cartridge integrally supports a photoreceptor, and at least one of a charger, a developing device, a transfer device, a cleaning device, and a decharging device. The process cartridge may be detachably mounted on image forming apparatuses.

FIG. 30 is a schematic view illustrating an exemplary embodiment of a process cartridge. A process cartridge 700 includes a photoreceptor 701, a charger 702, a developing device 704, a transfer device 708, a cleaning device 707, and a decharging device, not shown. The photoreceptor 701 is charged by the charger 702 and irradiated by an irradiator 703 while rotating in a direction indicated by an arrow in FIG. 30 so that an electrostatic latent image is formed thereon. The electrostatic latent image is developed with a toner by the developing device 704 to form a toner image. The toner image is transferred onto a transfer medium 705. Residual toner particles remaining on the photoreceptor 701 without being transferred are removed by the cleaning device 707. The surface of the photoreceptor 701 thus cleaned is then decharged to prepare for the next image formation.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### (Preparation of Colorant Dispersion)

At first, 20 parts of a carbon black (REGAL® 400 from Cabot Corporation) and 2 parts of a colorant dispersing agent (AJISPER® PB-821 from Ajinomoto Fine-Techno Co., Inc.) are primarily dispersed in 78 parts of ethyl acetate using a mixer equipped with agitation blades. The resultant primary dispersion is subjected to a dispersing treatment using a DYNO-MILL so that the colorant (i.e., carbon black) is more finely dispersed and aggregations thereof are completely removed by application of strong shear force. The resultant secondary dispersion is filtered with a filter (made of PTFE) having 0.45 μm-sized fine pores. Thus, a colorant dispersion is prepared.

### (Preparation of Wax Dispersion)

A container equipped with a stirrer and a thermometer is charged with 30 parts of a polyester resin (having a weight average molecular weight (Mw) of 30,000 and a glass transition temperature (Tg) of 60° C., and including no THF-insoluble component), 10 parts of a carnauba wax, and 160 parts of ethyl acetate. The mixture is heated to 85° C. and agitated for 20 minutes so that the polyester resin and the carnauba wax are dissolved in the ethyl acetate. The solution is then rapidly cooled so that fine particles of the carnauba wax are deposited. The resultant dispersion is subjected to a dispersion treatment using a bead mill (LABSTAR LMZ06 from Ashizawa Finetech Ltd.) filled with zirconia beads having a diameter of 0.1 μm, so that the resultant wax particles have an average particle diameter of 0.3 μm and a maximum particle diameter of 0.8 μm or less. The particle diameter of wax particles is measured using NPA 150 (from Microtrac).

### (Preparation of Toner Components Liquid)

At first, 50 parts of the colorant dispersion, 100 parts of the wax dispersion, 337.5 parts of a 20% (solid basis) ethyl acetate solution of the polyester resin (having a weight average molecular weight (Mw) of 30,000 and a glass transition temperature (Tg) of 60° C., and including no THF-insoluble component) which is used for the wax dispersion, 10 parts of a 15% (solid basis) ethyl acetate solution of a polycondensation reaction product of a phenol with an aldehyde (FCA-2508N from Fujikura Kasei Co., Ltd.), and 2.5 parts of ethyl acetate are mixed for 10 minutes using a mixer equipped with agitation blades. Thus, a toner components liquid (1) including 20% by weight of solid components is prepared.

### (Preparation of Toner)

The toner components liquid (1) is sprayed into nitrogen atmosphere at 45° C. using a two-fluid nozzle having a nozzle diameter of 250 μm with an air pressure of 0.15 MPa. The liquid droplets thus sprayed are collected by cyclone and blow-dried for 1 day at 40° C., 90% RH and 3 days at 40° C., 50% RH. Thus, black fine particles are prepared.

The black fine particles are subjected to wind power classification so that the resultant particles have a weight average particle diameter of 6.8 μm, a ratio (D4/Dn) of the weight average particle diameter to the number average particle diameter of 1.23, and an average circularity of 0.97. Thus, a mother toner (a) is prepared. The mother toner (a) includes the polycondensation reaction product of a phenol with an aldehyde in an amount of 1.5% by weight.

### (Preparation of Carrier)

To prepare a coating layer forming liquid, 100 parts of a silicone resin (organo straight silicone), 100 parts of toluene, 5 parts of γ-(2-aminoethyl)aminopropyl trimethoxysilane, and 10 parts of a carbon black are mixed for 20 minutes using a HOMOMIXER.

The coating layer forming liquid is applied on the surfaces of 100 parts of spherical magnetite particles having a particle diameter of 50 μm using a fluidized bed coating device. Thus, a magnetic carrier is prepared.

### (Preparation of Developer)

To prepare a toner (A), 99.0 parts of the mother toner (a) are mixed with 1.0 part of a hydrophobized silica (HDK H2000 from Clariant Japan K. K.) using a HENSCHEL MIXER (from Mitsui Mining Co., Ltd.).

To prepare a two-component developer, first, 4 parts of the toner (A) and 96 parts of the magnetic carrier are exposed to an atmosphere of 20° C., 50% RH for 24 hours, and then mixed for 10 minutes using a ball mill in the atmosphere.

### Example 2

### (Preparation of Toner Components Liquid)

At first, 50 parts of the colorant dispersion, 100 parts of the wax dispersion, 337.5 parts of a 20% (solid basis) ethyl acetate solution of the polyester resin (having a weight average molecular weight (Mw) of 30,000 and a glass transition temperature (Tg) of 60° C., and including no THF-insoluble component) which is used for the wax dispersion, 10 parts of a 15% (solid basis) ethyl acetate solution of a polycondensation reaction product of a phenol with an aldehyde (FCA-2508N from Fujikura Kasei Co., Ltd.), and 502.5 parts of ethyl acetate are mixed for 10 minutes using a mixer equipped with agitation blades. Thus, a toner components liquid (2) including 10% by weight of solid components is prepared.

### (Preparation of Toner)

The toner components liquid (2) is supplied to the liquid droplet injection unit 2B including a ring vibration unit of the toner production apparatus 1B illustrated in FIG. 11. The toner components liquid (2) is discharged into nitrogen atmosphere at 45° C. to form liquid droplets under the following conditions.

Flow rate of dried air: 2.0 L/min for nitrogen gas for dispersion, 30.0 L/min for inner dried nitrogen gas

Inner temperature: 38 to 40° C.

Vibration frequency: 98 kHz

Application voltage of piezoelectric substance: 10 V

The discharged liquid droplets are dried into solid particles. The solid particles are collected by cyclone and blow-dried for 1 day at 40° C., 90% RH and 3 days at 40° C., 50% RH.

Thus, a mother toner (b) is prepared. The mother toner (b) has a weight average particle diameter of 5.1 μm, a ratio (D4/Dn) of the weight average particle diameter to the number average particle diameter of 1.12, and an average circularity of 0.96, and includes the polycondensation reaction product of a phenol with an aldehyde in an amount of 1.5% by weight.

The thin film 12 is a nickel plate having an outer diameter of 8.0 mm and a thickness of 20 μm on which circular nozzles having a diameter of 8 μm are provided. The nozzles are formed by electroforming. The nozzles are formed within the central region having a substantially circular shape having a diameter of about 5 mm, so that the distance between each of the holes is 100 μm (like hound's-tooth check). The number of effective nozzles is about 1,000.

### (Preparation of Developer)

The procedure for preparing two-component developer in Example 1 is repeated except for replacing the mother toner (a) with the mother toner (b).

### Example 3

### (Preparation of Toner)

The toner components liquid (2) is supplied to the liquid droplet injection unit 2A of the toner production apparatus 1A illustrated in FIG. 1. The toner components liquid (2) is discharged into nitrogen atmosphere at 45° C. to form liquid droplets under the following conditions.

Flow rate of dried air: 2.0 L/min for nitrogen gas for dispersion, 30.0 L/min for inner dried nitrogen gas

Inner temperature: 38 to 40° C.

Vibration frequency: 180 kHz

Application voltage of piezoelectric substance: 10 V

The discharged liquid droplets are dried into solid particles. The solid particles are collected by cyclone and blow-dried for 1 day at 40° C., 90% RH and 3 days at 40° C., 50% RH.

Thus, a mother toner (c) is prepared. The mother toner (c) has a weight average particle diameter of 5.0 μm, a ratio (D4/Dn) of the weight average particle diameter to the number average particle diameter of 1.07, and an average circularity of 0.96, and includes the polycondensation reaction product of a phenol with an aldehyde in an amount of 1.5% by weight.

The thin film 12 is a nickel plate having an outer diameter of 8.0 mm and a thickness of 20 μm on which circular nozzles having a diameter of 8 μm are provided. The nozzles are formed by electroforming. The nozzles are formed within the central region having a substantially circular shape having a diameter of about 5 mm, so that the distance between each of the holes is 100 μm (like hound's-tooth check). The number of effective nozzles is about 1,000.

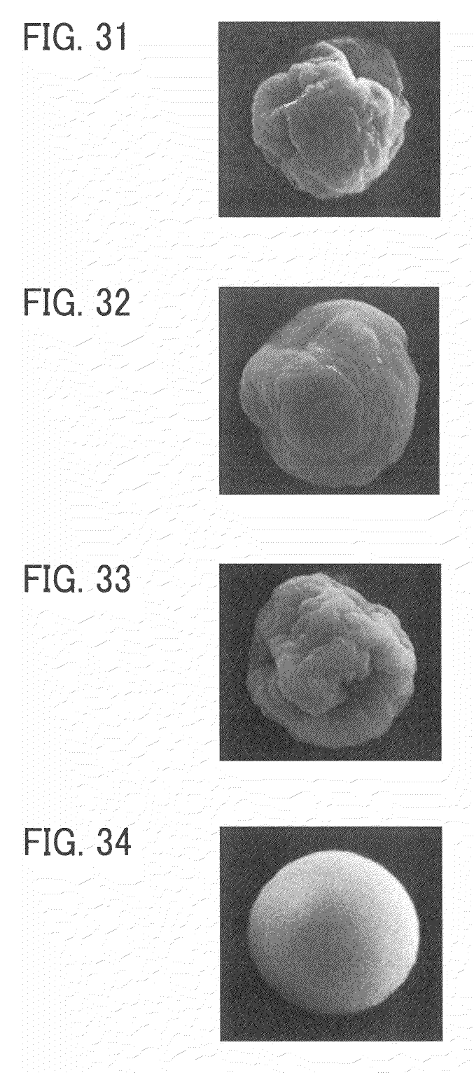

FIG. 31 is a SEM image of the mother toner (c).

### (Preparation of Developer)

The procedure for preparing two-component developer in Example 1 is repeated except for replacing the mother toner (a) with the mother toner (c).

### Example 4

### (Preparation of Toner)

The procedure for preparing the mother toner (c) in Example 3 is repeated except that the amount of the 20% (solid basis) ethyl acetate solution of the polyester resin (having a weight average molecular weight (Mw) of 30,000 and a glass transition temperature (Tg) of 60° C., and including no THF-insoluble component) is changed to 342.5 parts, the amount of the 15% (solid basis) ethyl acetate solution of a polycondensation reaction product of a phenol with an aldehyde (FCA-2508N from Fujikura Kasei Co., Ltd.) is changed to 3.33 parts, and the amount of the ethyl acetate is changed to 504.17 parts.

Thus, a mother toner (d) is prepared. The mother toner (d) has a weight average particle diameter of 5.0 μm, a ratio (D4/Dn) of the weight average particle diameter to the number average particle diameter of 1.08, and an average circularity of 0.98, and includes the polycondensation reaction product of a phenol with an aldehyde in an amount of 0.5% by weight.

FIG. 32 is a SEM image of the mother toner (d).

### (Preparation of Developer)

The procedure for preparing two-component developer in Example 1 is repeated except for replacing the mother toner (a) with the mother toner (d).

### Example 5

### (Preparation of Toner)

The procedure for preparing the mother toner (c) in Example 3 is repeated except that the amount of the 20% (solid basis) ethyl acetate solution of the polyester resin (having a weight average molecular weight (Mw) of 30,000 and a glass transition temperature (Tg) of 60° C., and including no THF-insoluble component) is changed to 330.0 parts, the amount of the 15% (solid basis) ethyl acetate solution of a polycondensation reaction product of a phenol with an aldehyde (FCA-2508N from Fujikura Kasei Co., Ltd.) is changed to 20.0 parts, and the amount of the ethyl acetate is changed to 500.0 parts.

Thus, a mother toner (e) is prepared. The mother toner (e) has a weight average particle diameter of 5.0 μm, a ratio (D4/Dn) of the weight average particle diameter to the number average particle diameter of 1.07, and an average circularity of 0.95, and includes the polycondensation reaction product of a phenol with an aldehyde in an amount of 3.0% by weight.

FIG. 33 is a SEM image of the mother toner (e).

### (Preparation of Developer)

The procedure for preparing two-component developer in Example 1 is repeated except for replacing the mother toner (a) with the mother toner (e).

### Example 6

### (Preparation of Toner)

The toner components liquid (2) is supplied to the liquid droplet injection unit 2C of the toner production apparatus 1C illustrated in FIG. 31. The toner components liquid (2) is discharged into nitrogen atmosphere at 45° C. to form liquid droplets and the discharged liquid droplets are dried into solid particles. The solid particles are collected by cyclone.

The thin film 12 is an SOI substrate having a thickness of 500 μm on which two-step shaped nozzles are provided. Referring to FIGS. 26A to 26D, the nozzle has a first aperture 215 having a diameter of 100 μm and a second aperture 216 having a diameter of 8.5 μm. The thin film 12 is disposed so that the toner components liquid is discharged from the second apertures 216. The distance between each of the nozzles is 100 μm (like hound's-tooth check). The retention part 14 is divided into multiple retention regions 29. The configurations of the retention part 14 are as follows.

Vibration (Resonance) frequency: 32.7 kHz

Number of retention regions: 6

Longitudinal dimension A: 8 mm

Lateral dimension B: 8 mm

Number of nozzles per retention region: 480

The solid particles are further blow-dried for 1 day at 40° C., 90% RH and 3 days at 40° C., 50% RH.

Thus, a mother toner (f) is prepared. The mother toner (f) has a weight average particle diameter of 4.9 μm, a ratio (D4/Dn) of the weight average particle diameter to the number average particle diameter of 1.06, and an average circularity of 0.96, and includes the polycondensation reaction product of a phenol with an aldehyde in an amount of 1.5% by weight.

### (Preparation of Developer)

The procedure for preparing two-component developer in Example 1 is repeated except for replacing the mother toner (a) with the mother toner (f).

### Comparative Example 1

### (Preparation of Toner)

First, 83.5 parts of a polyester resin (having a weight average molecular weight (Mw) of 30,000 and a glass transition temperature (Tg) of 60° C., and including no THF-insoluble component), 10 parts of a carbon black (MOGUL L from Cabot Corporation), 1.5 parts of a polycondensation reaction product of a phenol with an aldehyde, and 5 parts of a carnauba wax are mixed using HENSHEL MIXER MF20C/I (from Mitsui Mining Co., Ltd.). The mixture is kneaded using a twin screw extruder (from Toshiba Machine Co., Ltd.) so that the kneaded mixture has an outlet temperature of about 120° C., and rolled by two rollers which are cooled. The rolled mixture is further cooled on a steel belt. The cooled mixture is coarsely pulverized using ROATPLEX and finely pulverized using a jet mill. The pulverized particles are classified by a wind power classifier.

Thus, a mother toner (g) is prepared. The mother toner (g) has a weight average particle diameter of 7.1 μm, a ratio (D4/Dn) of the weight average particle diameter to the number average particle diameter of 1.25, and an average circularity of 0.95, and includes the polycondensation reaction product of a phenol with an aldehyde in an amount of 1.5% by weight.

### (Preparation of Developer)

The procedure for preparing two-component developer in Example 1 is repeated except for replacing the mother toner (a) with the mother toner (g).

### Comparative Example 2

### (Preparation of Toner)

The procedure for preparing the mother toner (a) in Example 1 is repeated except that the 15% (solid basis) ethyl acetate solution of a polycondensation reaction product of a phenol with an aldehyde (FCA-2508N from Fujikura Kasei Co., Ltd.) is replaced with a 15% (solid basis) ethyl acetate solution of a zinc salicylate compound (E-84 from Orient Chemical Industries Co., Ltd.).

Thus, a mother toner (h) is prepared. The mother toner (h) has a weight average particle diameter of 6.1 μm, a ratio (D4/Dn) of the weight average particle diameter to the number average particle diameter of 1.24, and an average circularity of 1.00.

### (Preparation of Developer)

The procedure for preparing two-component developer in Example 1 is repeated except for replacing the mother toner (a) with the mother toner (h).

### Comparative Example 3

### (Preparation of Toner)

The procedure for preparing the mother toner (b) in Example 2 is repeated except that the 15% (solid basis) ethyl acetate solution of a polycondensation reaction product of a phenol with an aldehyde (FCA-2508N from Fujikura Kasei Co., Ltd.) is replaced with a 15% (solid basis) ethyl acetate solution of a zinc salicylate compound (E-84 from Orient Chemical Industries Co., Ltd.).

Thus, a mother toner (i) is prepared. The mother toner (i) has a weight average particle diameter of 5.0 μm, a ratio (D4/Dn) of the weight average particle diameter to the number average particle diameter of 1.14, and an average circularity of 1.00.

### (Preparation of Developer)

The procedure for preparing two-component developer in Example 1 is repeated except for replacing the mother toner (a) with the mother toner (i).

### Comparative Example 4

### (Preparation of Toner)

The procedure for preparing the mother toner (c) in Example 3 is repeated except that the 15% (solid basis) ethyl acetate solution of a polycondensation reaction product of a phenol with an aldehyde (FCA-2508N from Fujikura Kasei Co., Ltd.) is replaced with a 15% (solid basis) ethyl acetate solution of a zinc salicylate compound (E-84 from Orient Chemical Industries Co., Ltd.).

Thus, a mother toner (j) is prepared. The mother toner (j) has a weight average particle diameter of 5.0 μm, a ratio (D4/Dn) of the weight average particle diameter to the number average particle diameter of 1.09, and an average circularity of 1.00.

### (Preparation of Developer)

The procedure for preparing two-component developer in Example 1 is repeated except for replacing the mother toner (a) with the mother toner (j).

### Comparative Example 5

### (Preparation of Toner)

The procedure for preparing the mother toner (c) in Example 3 is repeated except that the 15% (solid basis) ethyl acetate solution of a polycondensation reaction product of a phenol with an aldehyde (FCA-2508N from Fujikura Kasei Co., Ltd.) is no added.

Thus, a mother toner (k) is prepared. The mother toner (k) has a weight average particle diameter of 5.1 μm, a ratio (D4/Dn) of the weight average particle diameter to the number average particle diameter of 1.08, and an average circularity of 1.00.

FIG. 34 is a SEM image of the mother toner (k).

### (Preparation of Developer)

The procedure for preparing two-component developer in Example 1 is repeated except for replacing the mother toner (a) with the mother toner (j).

### Evaluations

### (Weight Average Molecular Weight (Mw))

A molecular weight distribution of THF-soluble components of a resin is measured by a GPC (gel permeation chromatography) measuring device GPC-150C (from Waters) equipped with SHODEX® columns KF801 to 807 (from Showa Denko K.K.). The columns are stabilized in a heat chamber at 40° C. and a solvent (THF) is flowed therein at a flow rate of 1 ml/min. A specimen is prepared by dissolving 0.05 g of a resin in 5 g of THF and filtering the solution with a preparation filter (CHROMATO DISC with a pore size of 0.45 μm from Kurabo Industries Ltd.). The resultant specimen is a THF solution of the resin in an amount of from 0.05 to 0.6% by weight. From 50 to 200 μl of the specimen are injected in the GPC measuring device. A molecular weight distribution of the resin is determined from a calibration curve created from at least 10 monodisperse polystyrene standard samples, available from Pressure Chemical Co., Tohso Corporation, etc., each having molecular weights of 6×10², 2.1×10², 4×10², 1.75×10⁴, 5.1×10⁴, 1.1×10⁵, 3.9×10⁵, 8.6×10⁵, 2×10⁶, and 4.48×10⁶. The detector is an RI (refractive index) detector.

### (THF-Insoluble Components)

First, 10 g of a resin and 90 g of THF are mixed using a stirrer for 60 minutes at 20° C. The mixture is left for 20 to 30 hours at 20° C. so that THF-insoluble components are precipitated. The precipitated THF-insoluble components are separated by suction filtration using ADVANTEC® FILTER PAPER No. 7 (from Toyo Roshi Kaisha, Ltd.) while washing the separated THF-insoluble components with THF. The separated THF-insoluble components are heated to 120° C. for 3 hours so that THF is evaporated. The THF-soluble components are weighed and the weight ratio of the THF-soluble components to 10 g of the resin is calculated.

### (Particle Diameter Distribution)

The weight average particle diameter (D4) and number average particle diameter (Dn) of toners are measured by a particle size measuring instrument MULTISIZER III (from Beckman Coulter K. K.) with an aperture diameter of 100 μm and an analysis software Beckman Coulter Multisizer 3 Version 3.51. First, 0.5 ml of a 10% by weight surfactant (an alkylbenzene sulfonate NEOGEN SC-A from Dai-ichi Kogyo Seiyaku Co., Ltd.) is contained in a 100-ml glass beaker, and 0.5 g of a toner is added thereto and mixed using a micro spatula. Next, 80 ml of ion-exchange water are further added to prepare a toner dispersion, and the toner dispersion is dispersed using an ultrasonic dispersing machine W-113MK-II (from Honda Electronics) for 10 minutes. The toner dispersion is then subjected to a measurement using a measuring instrument MULTISIZER III and a measuring solution ISOTON-III (from Beckman Coulter K. K.) while the measuring instrument indicates that the toner dispersion has a concentration of 8±2%. It is important to keep the toner dispersion to have a concentration of 8±2% so as not to cause measurement error.

Channels include the following 13 channels: 2.00 or more and less than 2.52 μm; 2.52 or more and less than 3.17 μm; 3.17 or more and less than 4.00 μm; 4.00 or more and less than 5.04 μm; 5.04 or more and less than 6.35 μm; 6.35 or more and less than 8.00 μm; 8.00 or more and less than 10.08 μm; 10.08 or more and less than 12.70 μm; 12.70 or more and less than 16.00 μm; 16.00 or more and less than 20.20 μm; 20.20 or more and less than 25.40 μm; 25.40 or more and less than 32.00 μm; and 32.00 or more and less than 40.30 μm. Namely, particles having a particle diameter of 2.00 μm or more and less than 40.30 μm can be measured.

The volume distribution and number distribution are calculated from the volume and number, respectively, of toner particles thus measured. The weight average particle diameter (D4) and number average particle diameter (Dn) are calculated from the volume distribution and number distribution. The ratio (D4/Dn) of the weight average particle diameter (D4) to the number average particle diameter (Dn) indicates the width of the particle diameter distribution. When the particle diameter distribution is monodisperse, the ratio (D4/Dn) is 1. As the ratio (D4/Dn) increases, the width of the particle diameter distribution increases.

### (Average Circularity)

The average circularity of a toner is determined using a flow-type particle image analyzer FPIA-2100 (from Sysmex Corp.). First, 0.1 to 0.5 ml of a surfactant (an alkylbenzene sulfonate) are added to 100 to 150 ml of water from which solid impurities have been removed, and 0.1 to 0.5 g of a toner are added thereto to prepare a toner dispersion. The toner dispersion is dispersed using an ultrasonic dispersing machine for about 1 minute to 3 minutes. The toner dispersion is then subjected to a measurement of shape distribution using the measuring instrument FPIA-2100 while the measuring instrument indicates that the toner dispersion has a concentration of from 3,000 to 10,000 particles/μl.

### (Chargeability)

First, 4 parts of a mother toner and 96 parts of the magnetic carrier are exposed to an atmosphere of 20° C., 50% RH (i.e., room temperature and humidity) for 24 hours, and subsequently mixed using a ball mill in the atmosphere for 30 seconds, 10 minutes, and 30 minutes. Thus, respective two-component developers D(30 sec), D(0 min), and D(30 min) are prepared. The charge quantity of each of the two-component developers D(30 sec), D(10 min), and D(30 min) is measured by a blow-off method to be described later. As the charge quantity of D(30 sec) approaches that of D(10 min), the toner can be more quickly chargeable. As the charge quantity of D(30 min) approaches that of D(10 min), the toner can be charged more reliably.

Similarly, 4 parts of a mother toner and 96 parts of the magnetic carrier are exposed to an atmosphere of 30° C., 90% RH (i.e., high temperature and humidity) for 24 hours, and subsequently mixed using a ball mill in the atmosphere for 10 minutes. Thus, a two-component developers D(high) is prepared. The charge quantity of the two-component developer D(high) is measured by a blow-off method to be described later. As the charge quantity of D(high) approaches that of D(10 min), the toner has better environmental stability.

The blow-off method is a method of measuring charge quantity of developer. In a metallic cylindrical container, both bottom surfaces of which are equipped with stainless meshes having openings of 20 μm, 6 g of a developer are contained. Nitrogen gas is blown on the metallic cylindrical container so that the toner in the developer is removed. The charge (q) of the remaining carrier is measured. The charge quantity (q/m) is defined as the charge per weight (m) of the toner.

### (Image Reliability)

A developer is set in a copier IMAGIO NEO C285 (from Ricoh Co., Ltd.). An image chart in which 2%, 10%, and 50%, respectively, of the area is occupied by images is continuously produced on 100 sheets of a paper TYPE 6000 (from Ricoh Co., Ltd.) at 30° C., 90% RH and 10° C., 30% RH. Image reliability is evaluated as follows.

A: The 100^{th} image quality is equivalent to the first image quality in every condition.

B: The 100^{th} image quality is slightly worse than the first image quality in at least one condition.

C: The 100^{th} image quality is worse than the first image quality in at least one condition.

### (Cleanability)

A developer is set in a copier IMAGIO NEO C325 (from Ricoh Co., Ltd.). An image chart in which 30% of the area is occupied by images is developed and transferred onto transfer paper. While residual toner particles remaining on the photoreceptor are being removed by a cleaning blade, the copier stops operation. (The cleaning blade has been already used while 20,000 sheets of copy is produced.) The residual toner particles still remaining on the photoreceptor are transferred onto SCOTCH® tape (from Sumitomo 3M Ltd.). The tape is adhered to white paper and subjected to a measurement of image density using a Macbeth refractive densitometer RD514. The measurement is performed 10 times by changing a measuring point, and the measured values are averaged. The averaged value of image density is hereinafter referred to as ID(A). Similarly, a blank tape is adhered to white paper and subjected to a measurement of image density. The image density of the blank tape is hereinafter referred to as ID (B). Cleanability is evaluated as follows.

A: ID(A)-ID(B) is 0.01 or less

B: ID(A)-ID(B) is 0.015 or less

C: ID(A)-ID(B) is greater than 0.015

The evaluation results are shown in Tables 1 to 3.

TABLE 1

| | D4 (μm) | D4/Dn | Average Circularity |
|---|---|---|---|
| Example 1 | 6.8 | 1.23 | 0.97 |
| Example 2 | 5.1 | 1.12 | 0.96 |
| Example 3 | 5.0 | 1.07 | 0.96 |
| Example 4 | 5.0 | 1.08 | 0.98 |
| Example 5 | 5.0 | 1.07 | 0.95 |
| Example 6 | 4.9 | 1.06 | 0.96 |
| Comparative Example 1 | 7.1 | 1.25 | 0.95 |
| Comparative Example 2 | 6.1 | 1.24 | 1.00 |
| Comparative Example 3 | 5.0 | 1.14 | 1.00 |
| Comparative Example 4 | 5.0 | 1.09 | 1.00 |
| Comparative Example 5 | 5.1 | 1.08 | 1.00 |

TABLE 2

| | Charge Quantity (μC/g) | | | |
|---|---|---|---|---|
| | | D | D | |
| | D (30 sec) | (10 min) | (30 min) | D (high) |
| Example 1 | −26.5 | −29.8 | −29.4 | −25.7 |
| Example 2 | −31.7 | −35.2 | −34.8 | −32.1 |
| Example 3 | −32.2 | −35.4 | −35.3 | −32.5 |
| Example 4 | −22.3 | −27.4 | −27.9 | −15.2 |
| Example 5 | −43.3 | −46.8 | −45.3 | −45.4 |
| Example 6 | −36.5 | −38.4 | −38.7 | −36.1 |
| Comparative Example 1 | −8.4 | −16.4 | −19.6 | −7.5 |
| Comparative Example 2 | −8.5 | −12.8 | −15.7 | −4.6 |
| Comparative Example 3 | −9.8 | −14.4 | −17.2 | −5.2 |
| Comparative Example 4 | −9.9 | −15.1 | −17.9 | −5.4 |
| Comparative Example 5 | −7.3 | −12.8 | −15.4 | −1.5 |

TABLE 3

| | Image Reliability | Cleanability |
|---|---|---|
| Example 1 | A | A |
| Example 2 | A | A |
| Example 3 | A | A |
| Example 4 | B | B |
| Example 5 | A | A |
| Example 6 | A | A |
| Comparative Example 1 | C | A |
| Comparative Example 2 | C | C |
| Comparative Example 3 | C | C |
| Comparative Example 4 | C | C |
| Comparative Example 5 | C | C |

This document claims priority and contains subject matter related to Japanese Patent Applications Nos. 2008-190078 and 2009-007857, filed on Jul. 23, 2008 and Jan. 16, 2009, respectively, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner produced by a method comprising:
dissolving or dispersing toner components comprising a binder resin, a colorant, and a charge controlling agent in an organic solvent to prepare a toner components liquid;
forming liquid droplets of the toner components liquid in a gas phase; and
solidifying the liquid droplets into toner particles of the toner,
wherein the charge controlling agent comprises a polycondensation reaction product of a phenol with an aldehyde.

2. The toner according to claim 1, wherein the liquid droplets are formed by periodically discharging the toner components liquid from multiple nozzles each having the same aperture diameter using a mechanical vibration unit.

3. The toner according to claim 2, wherein the multiple nozzles are formed on a thin film that is vibrated by the mechanical vibration unit.

4. The toner according to claim 3, wherein the mechanical vibration unit is a circular vibration unit that is provided surrounding the nozzles on the thin film.

5. The toner according to claim 3, wherein the mechanical vibration unit includes a vibration surface that is parallel to the thin film, and the vibration surface vibrates in a vertical direction.

6. The toner according to claim 5, wherein the liquid droplets are discharged from the multiple nozzles periodically by liquid resonance.

7. The toner according to claim 5, wherein the mechanical vibration unit is a horn vibrator.

8. The toner according to claim 1, wherein the toner includes the charge controlling agent in an amount of from 0.1 to 5 parts by weight based on 100 parts by weight of the toner components.

9. The toner according to claim 1, wherein the toner has a weight average particle diameter of from 1 to 10 μm, and a particle diameter distribution that is a ratio of a weight average particle diameter to a number average particles diameter of the toner is from 1.00 to 1.15.

10. The toner according to claim 1, wherein the toner has an average circularity of from 0.94 to 0.98.

11. A developer, comprising the toner according to claim 1 and a carrier.

12. An image forming apparatus, comprising:
an electrostatic latent image bearing member;
an electrostatic latent image forming device configured to form an electrostatic latent image on the electrostatic latent image bearing member;
a developing device configured to develop the electrostatic latent image bearing with the toner according to claim 1 to form a toner image;
a transfer device configured to transfer the toner image onto a recording medium; and
a fixing device configured to fix the toner image on the recording medium by application of heat and pressure from a roller-shaped or belt-shaped fixing member.
